(19) United States
(12) Patent Application Publication
(10) Pub. No.: US 2025/0382710 A1
(43) Pub. Date: Dec. 18, 2025

(54) LOW VOLTAGE ELECTROLYZER AND METHODS OF USING THEREOF

(71) Applicant: Sublime Systems, Inc., Somerville, MA (US)

(72) Inventors: Michael C. STERN, Sudbury, MA (US); Jesse D. BENCK, Wakefield, MA (US); Yet-Ming CHIANG, Wellesley, MA (US)

(73) Assignee: Sublime Systems, Inc., Somerville, MA (US)

(21) Appl. No.: 18/878,340

(22) PCT Filed: Jun. 23, 2023
(86) PCT No.: PCT/US2023/069007

§ 371 Date: Dec. 23, 2024

Related U.S. Application Data
(60) Provisional application No. 63/366,943, filed on Jun. 24, 2022.

(51) Int. Cl. C25B 3/07; B01D 53/62; B01D 53/78; B01D 53/96; C25B 1/04; C25B 9/19; C25B 9/21

(52) U.S. Cl. CPC C25B 3/07; B01D 53/62; B01D 53/78; B01D 53/965; C25B 1/04; C25B 9/19; C25B 9/21; B01D 2257/504

(57) ABSTRACT

Disclosed herein are low voltage electrolyzers and methods and systems of using those low voltage electrolyzers. Specifically, the electrolyzers can include a pH buffer in the catholyte and/or anolyte of the electrolyzer and generating a gas at the cathode or anode that is consumed at the other of the cathode or anode to reduce the open-circuit potential.

### CROSS-REFERENCE TO RELATED APPLICATIONS

This application claims the benefit of U.S. Provisional Application No. 63/366,943 filed Jun. 24, 2022, the entire contents of which are incorporated herein by reference.

### FIELD OF THE DISCLOSURE

This disclosure relates to low voltage electrolyzers and systems and methods of using thereof. More specifically, this disclosure relates to low voltage electrolyzers wherein the catholyte and/or anolyte acts as a pH buffer and gas evolved at one of the electrodes is consumed at the other electrode.

### BACKGROUND OF THE DISCLOSURE

Electrolyzers use electricity to induce chemical reactions. In some cases, the products of these reactions can then be sold or used in downstream processes to generate other chemicals and/or products.

### SUMMARY OF THE DISCLOSURE

Disclosed herein are low voltage electrolyzers and systems and methods of using these low voltage electrolyzers. Specifically, the electrolyzers disclosed herein may have a reduced energy consumption compared to traditional chlor-alkali electrolyzers or other salt splitting electrolyzers due to the reduced voltages required to drive the electrochemical process of the electrolyzers. To reduce the overall voltage required to drive the electrochemical processes, the electrolyzers can include a pH buffer in the catholyte and/or anolyte and/or are configured such that a gas generated at the cathode or anode compartment can be consumed at the other of the cathode or anode compartment to generate an acid and/or base. A pH buffer can allow the anolyte and/or catholyte to help retain the anions and/or cations of the generated acid and/or base in the anolyte and/or catholyte instead of having these anions and/or cations cross the ion-selective barrier separating the anode compartment and the cathode compartment. In other words, the pH buffer can reduce or mitigate the migration of protons and/or hydroxides across the ion-selective barrier separating the anode compartment and the cathode compartment. This combination of features can allow the electrolyzer to operate with significantly less energy consumption compared to current technologies.

For example, in some embodiments, a hydrogen gas can be generated in the cathode compartment of an electrolyzer and then sent to the anode compartment of the electrolyzer. The hydrogen gas at the anode compartment can be oxidized to create hydronium ions or protons which can be used to generate an acid in the anolyte compartment. A pH buffer in the anolyte can help retain those hydronium ions or protons in the anolyte compartment rather than losing them through the ion-selective barrier to the catholyte compartment. This can reduce the overall voltage required to drive the electrochemical processes of the electrolyzer.

In some embodiments, a method includes generating hydrogen gas in a cathode compartment of an electrolyzer, wherein the cathode compartment comprises a catholyte and a cathode; sending the hydrogen gas to an anode-containing compartment of the electrolyzer, wherein the anode-containing compartment comprises an anode and is separated from an anolyte compartment comprising a pH buffer by a first ion-selective barrier and the anolyte compartment is separated from the cathode compartment by a second ion-selective barrier; oxidizing the hydrogen gas in the anode-containing compartment generating protons; and generating an acid in the anolyte compartment with the protons received through the ion-selective barrier. In some embodiments, the open-circuit potential of the electrolyzer is less than 1 volt. In some embodiments, the pH buffer comprises a weak acid and its conjugate base. In some embodiments, the weak acid comprises acetic acid, a bicarbonate, or a bisulfate and the conjugate base comprises acetate, a carbonate, or a sulfate. In some embodiments, the method includes dissolving a feedstock material comprising a target element with the acid and precipitating and/or electrodepositing the target element from the dissolved feedstock material. In some embodiments, precipitating and/or electrodepositing the target element from the dissolved feedstock material uses the catholyte. In some embodiments, the method includes separating the hydrogen gas from the catholyte. In some embodiments, the method includes capturing an acid gas from a gas mixture with the catholyte and sending the catholyte with the captured acid gas to the anolyte compartment. In some embodiments, the method includes generating an acid gas in the anolyte compartment. In some embodiments, the method includes separating the acid gas from the anolyte.

In some embodiments, a system includes an electrolyzer comprising: a cathode compartment comprising a catholyte and a cathode; and an anode compartment comprising an anolyte compartment comprising a pH buffer and an anode-containing compartment comprising an anode, wherein: the cathode compartment is separated from the anode compartment by a first ion-selective barrier and the anolyte compartment is separated from the anode-containing compartment by a second ion-selective barrier; the cathode compartment is configured to generate hydrogen gas; the anode-containing compartment is configured to receive the hydrogen gas and oxidize the hydrogen gas generating protons; and the anolyte compartment is configured to receive the protons through the second ion-selective barrier and generate an acid. In some embodiments, the system includes a dissolution reactor configured to receive the acid from the anolyte compartment and dissolve a feedstock material comprising a target element. In some embodiments, the system includes a precipitation reactor configured to receive the dissolved feedstock material and precipitate the target element from the dissolved feedstock material. In some embodiments, the system includes a gas/liquid separator configured to receive a catholyte exit stream from the cathode compartment and separate the catholyte exit stream into hydrogen gas and the catholyte. In some embodiments, the hydrogen gas from the gas/liquid separator is sent to the anode-containing compartment. In some embodiments, at least a portion of the catholyte from the gas/liquid separator is sent to the cathode compartment. In some embodiments, at least a portion of the catholyte from the gas/liquid separator is sent to a precipitation reactor to precipitate a target element from a dissolved feedstock material. In some embodiments, the system includes an absorber configured to receive a portion of the catholyte from the gas/liquid separator, to receive a gas mixture comprising an acid gas, and to capture the acid gas in the catholyte. In some embodiments, the catholyte with the captured acid gas is sent to the anolyte compartment. In some embodiments, the anolyte compartment is configured to generate an acid gas. In some embodiments, the system includes a second gas/liquid separator configured to receive an anolyte product and separate the anolyte product into an acid gas and the anolyte. In some embodiments, at least a portion of the anolyte from the second gas/liquid separator is sent to the anolyte compartment. In some embodiments, the electrolyzer has an open-circuit potential of less than 1 volt. In some embodiments, the pH buffer comprises a weak acid and its conjugate base. In some embodiments, the weak acid comprises acetic acid, a bicarbonate, or a bisulfate and the conjugate base comprises acetate, a carbonate, or a sulfate.

In some embodiments, an electrolyzer includes a cathode compartment comprising a catholyte and a cathode; and an anode compartment comprising an anolyte compartment comprising a pH buffer and an anode-containing compartment comprising an anode, wherein: the cathode compartment is separated from the anode compartment by a first ion-selective barrier and the anolyte compartment is separated from the anode-containing compartment by a second ion-selective barrier; the cathode compartment is configured to generate hydrogen gas; the anode-containing compartment is configured to receive the hydrogen gas and oxidize the hydrogen gas generating protons; and the anolyte compartment is configured to receive the protons through the second ion-selective barrier and generate an acid. In some embodiments, the electrolyzer has an open-circuit potential of less than 1 volt. In some embodiments, the pH buffer comprises a weak acid and its conjugate base. In some embodiments, the weak acid comprises acetic acid, a bicarbonate, or a bisulfate and the conjugate base comprises acetate, a carbonate, or a sulfate.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a methods, systems, and electrolyzers, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

The invention will now be described, by way of example only, with reference to the accompanying drawings.

FIG. 1A illustrates an example of a dissolution and precipitation system in accordance with some embodiments disclosed herein.

FIG. 1B illustrates another example of a dissolution and precipitation system in accordance with some embodiments disclosed herein.

FIG. 1C illustrates a third example of a dissolution and precipitation system in accordance with some embodiments disclosed herein.

FIG. 2 illustrates an electrolyzer diagram showing example reactions for a dissolution and precipitation system in accordance with some embodiments disclosed herein.

FIG. 3A illustrates an example of a gas separation system in accordance with some embodiments disclosed herein.

FIG. 3B illustrates another example of a gas separation system in accordance with some embodiments disclosed herein.

FIG. 3C illustrates a third example of a gas separation system in accordance with some embodiments disclosed herein.

FIG. 4 illustrates an electrolyzer diagram showing example reactions for a gas separation system in accordance with some embodiments disclosed herein.

FIG. 5 illustrates an example of a metal leaching system in accordance with some embodiments disclosed herein.

FIG. 6A illustrates an example of a silica leaching/upgrading system in accordance with some embodiments disclosed herein.

FIG. 6B illustrates another example of a silica leaching/upgrading system in accordance with some embodiments disclosed herein.

FIG. 7 illustrates an electrolyzer diagram showing example reactions for a silica leaching/upgrading system in accordance with some embodiments disclosed herein.

FIG. 8 illustrates an exemplary setup tested in a laboratory setting to simulate the performance of the electrolyzer described in calcium leaching in accordance with some embodiments disclosed herein.

FIG. 9 illustrates the pH measured of the catholyte and anolyte over time of the system of FIG. 8 in accordance with some embodiments disclosed herein.

FIG. 10 illustrates the voltage of the electrolyzer over time of the system of FIG. 8 in accordance with some embodiments disclosed herein.

FIG. 11 illustrates an exemplary setup tested in a laboratory setting to simulate the performance of the electrolyzer described in gas separation in accordance with some embodiments disclosed herein.

FIG. 12 illustrates the pH measured of the catholyte and anolyte over time of the system of FIG. 11 in accordance with some embodiments disclosed herein.

FIG. 13 illustrates the voltage of the electrolyzer over time of the system of FIG. 11 in accordance with some embodiments disclosed herein.

FIG. 14 illustrates an exemplary setup tested in a laboratory setting to simulate the performance of the electrolyzer described in metal leaching in accordance with some embodiments disclosed herein.

FIG. 15 illustrates the evolution of CO₂ over time of the system of FIG. 14 in accordance with some embodiments disclosed herein.

FIG. 16 illustrates the voltage of the electrolyzer over time of the system of FIG. 14 in accordance with some embodiments disclosed herein.

In the Figures, like reference numerals refer to like components unless otherwise stated herein.

### DETAILED DESCRIPTION OF THE DISCLOSURE

Disclosed herein are low voltage electrolyzers and systems and methods of using these low voltage electrolyzers. Specifically, the electrolyzers disclosed herein may have a reduced energy consumption compared to traditional chlor-alkali electrolyzers or other salt splitting electrolyzers due to the reduced voltages required to drive the electrochemical process of the electrolyzers. In some embodiments, the electrolyzers disclosed herein can reduce the open-circuit potential by about 50% or more and total energy (compared to traditional chlor-alkali electrolyzers or other salt splitting electrolyzers). In some embodiments, the electrolyzers disclosed herein can be about 10-40% more efficient (than traditional chlor-alkali electrolyzers or other salt splitting electrolyzers). To reduce the overall voltage required to drive the electrochemical processes, a pH buffer in the catholyte and/or anolyte can reduce or mitigate the migration of hydronium ions or protons and/or hydroxides across the ion-selective barrier separating the anode compartment and the cathode compartment. In addition, a gas generated at the cathode or anode compartment can be consumed at the other of the electrode to generate an acid and/or base in the catholyte or anolyte. This combination of features can allow the electrolyzer to operate with significantly less energy consumption compared to current technologies.

Examples of electrolyzers that produce acids and/or bases and systems that use acids and bases for chemical dissolution and precipitation have been described in U.S. Pat. App. No. 62/818,604, filed Mar. 14, 2019; U.S. Pat. App. No. 62/887,143, filed Aug. 15, 2019; U.S. Pat. App. No. 62/962,061, filed Jan. 16, 2020; PCT Application No. PCT/US2020/022672, filed Mar. 13, 2020; and PCT Application No. PCT/US2020/01387, filed Jan. 16, 2020, the entire contents of all of these applications are hereby incorporated by reference. In addition, examples of electrochemical reactors used for the purpose of cyclic acid gas scrubbing are described U.S. Pat. No. 10,625,209, the entire contents of which are hereby incorporated by reference.

In some embodiments, the chemical reactions induced by electrolyzers can be used as reversible reactants and/or catalyze a cyclic process such as a dissolution/precipitation cycle, a gas absorption and desorption cycle, and/or as a regenerable catalyst. When performing cyclic processes, it can be advantageous to minimize the energy consumption of the electrolyzer as much as possible while still achieving the desired performance. Minimization can be achieved through efficient design of the electrolyzer (e.g., to reduce losses due to overpotentials and ionic resistances) and/or through appropriate selection of the electrically active species that are reduced in the cathode and oxidized in the anode. One example of energy minimization in a non-cyclic process can be the use of an oxygen-depolarized cathode in chlorine production. In an oxygen-depolarized cathode, the reaction can consume oxygen, rather than the tradition generation of hydrogen, leading to a lower energy requirement.

In many cyclic processes, the desired performance can be achieved through the sequential addition of an acid then base or base then acid. Acids and bases can be generated from an electrolyzer in the well-known chlor-alkali process when the produced hydrogen and chlorine from the process are combined to form hydrochloric acid. This chlor-alkali process, however, can be highly energy intensive and use of an oxygen-depolarized cathode may eliminate the necessary hydrogen required to form hydrochloric acid.

Other electrolyzer designs based on a hydrogen depolarized anode have been proposed to reduce the energy demand but these may require the use of both cation and anion exchange membranes and multiple compartments leading to significant ohmic potential drops and high energy requirements. An example of this is disclosed in U.S. Pat. No. 7,993,500, which is hereby incorporated by reference in its entirety. The additional ion selective membranes and compartments may be required to prevent undesirable back-migration of acidic (protons or hydronium ions) and basic (hydroxide ions) species that reduce Faradaic efficiencies and increase total energy consumption. If additional ion-selective membranes and compartments are not added, the maximum concentrations of acid and/or bases that can be generated may be limited as shown in the data of U.S. Pat. No. 4,561,945 (which is hereby incorporated by reference in its entirety), that only achieved 12% NaOH and 11.1% H₂SO₄ concentrations and did so at low Faradaic efficiencies (60-80%).

In addition, Tang et al.'s Hydrogen-motivated electrolysis of sodium carbonate with extremely low cell voltage (Chemical Communications), February 2018 (which is hereby incorporated by reference in its entirety) also describes a hydrogen depolarized electrode where sodium hydroxide (NaOH) is produced in the catholyte and sodium carbonate (Na₂CO₃) is consumed in the anolyte to produce sodium bicarbonate and/or CO₂. This process yielded significantly lower energy consumption but was not a cyclic process and, therefore, was not suitable for many large scale processes where costs to purchase and/or dispose of byproducts would be untenable.

In some embodiments, a system disclosed herein can include an electrolyzer. In some embodiments, the electrolyzer can include a cathode compartment and an anode compartment. For example, in the Figures, electrolyzer 1 can include a cathode compartment 2 and an anode compartment 3.

In some embodiments, the anode compartment and the cathode compartment can be separated by an ion-selective barrier 6. In some embodiments, the ion-selective barrier can be a cation-selective barrier or an anion-selective barrier. In some embodiments, cation-selective barriers can use sulfonic acid groups, carboxylic acid groups, and/or phosphoric acid groups to create the cation-selective environment and include a variety of materials made by Chemours under the trade name Nafion™. In some embodiments, anion selective barriers, similarly, can use acidic functional groups to create an anion-selective environment. In some embodiments, the ion-selective barrier may be in the form of membranes, supported membranes, gels, resins, and/or coatings. In some embodiments, the anode compartment and the cathode compartment can be separated by a non-ion-selective barrier. Barriers that are not ion-selective may be porous or non-porous and can include asbestos diaphragms, Zirfon separators, salt bridges, polymer membranes, gels, and/or coatings.

In some embodiments, the cathode compartment can include a cathode and a catholyte. In some embodiments, the catholyte can be a liquid or a solution in aqueous form. In some embodiments, the cathode can be in contact with the catholyte. In some embodiments, the cathode can be submerged in the catholyte. For example, some Figures illustrate cathode 4 in the cathode compartment. In some embodiments, the cathode compartment can include a cathode-containing compartment that includes the cathode and a catholyte compartment that includes the catholyte. In some embodiments, the cathode-containing compartment and the catholyte compartment can be separated by an ion or non-ion selective barrier. The ion or non-ion selective barrier can be any of those disclosed herein. In some embodiments, the ion or non-ion selective barrier between the cathode-containing compartment and the catholyte compartment can prevent the cathode-containing compartment from being flooded by the catholyte and/or the cathode from being poisoning by the catholyte. For example, the cathode-containing compartment can be configured to receive a gas (e.g., oxygen) and the barrier can prevent flooding of the gas cathode-containing compartment. In some embodiments, the cathode in the cathode-containing compartment is adjacent to or in direct contact with the ion or non-ion selective barrier between the cathode-containing compartment and the catholyte compartment.

In some embodiments, the cathode may support the hydrogen evolution reaction (HER). In some embodiments, the cathode can be a depolarized cathode. In some embodiments, the cathode can be an oxygen depolarized cathode or other gas (e.g., chlorine) depolarized cathode. In some embodiments, depolarized cathodes can reduce the energy requirement of the electrolyzer by reducing or eliminating the unnecessary net generation of energy intensive hydrogen gas. In some embodiments, the cathode may be composed of a steel, nickel, carbon, or other conductive materials. In some embodiments, the cathode can be a conductive material known in the art of alkaline electrolyzers to promote the HER where hydronium ions and/or water are reduced to form hydrogen, water, and hydroxide ions. In some embodiments, the cathode, in contact with the catholyte, may be either an electrode suited for promoting the HER as described above or an oxygen-depolarized cathode that consumes oxygen.

In some embodiments, the catholyte can be a portion of the electrolyte adjacent to the cathode. In some embodiments, the catholyte can include a base. In some embodiments, the catholyte can include a strong base (e.g., alkali metal base such as sodium hydroxide or potassium hydroxide or alkaline earth metal base). In some embodiments, the catholyte and/or the anolyte can act as a pH buffer to prevent significant changes in the pH in the event of the addition or removal of acidic or basic components.

In some embodiments, the catholyte can include or be a pH buffer. In some embodiments, the catholyte can have a dissolved component therein that can act as a pH buffer. The pH buffer can keep the pH at a nearly constant value while amounts of acids and/or bases are added (or created in) to the pH buffer. In some embodiments, the pH buffer can prevent significant changes in the pH of the catholyte in the event of the addition or removal of acidic or basic components. In some embodiments, the catholyte can include ammonium acetate.

In some embodiments, the catholyte pH buffer can include a weak base and the conjugate acid of the weak base. In some embodiments, the weak base can have a pKa less than or equal to 13 and greater than or equal to 1 or less than or equal to 12 and greater than or equal to 5. In some embodiments, the weak base can include ammonia, amines, carbonates, bicarbonates, dibasic phosphates, tribasic phosphate, borates, thiols, phenols, etc., or combinations thereof. In some embodiments, the conjugate acid can include ammonium, protonated amines, bicarbonates, carbonic acid, dibasic phosphates, monobasic phosphates, boric acid, protonated thiols, and/or phenols salts. For example, in some embodiments, the inlet catholyte to the cathode compartment can include a weak base (e.g., ammonia), a salt of the conjugate acid of the weak base (e.g., ammonium chloride). In some embodiments, the catholyte can also include an inert dissociated salt to increase the conductivity of the catholyte. In some embodiments, the inert dissociated salt can be chloride salts such as sodium or potassium chloride, salts of nitrates, sulfates, perchlorates, etc. and/or combinations thereof. In some embodiments, the fraction of the weak base present in its conjugate acid form may be greater than about 0%, about 10%, about 20%, about 30%, about 40%, about 50%, about 60%, about 70%, about 80%, or about 90%. In some embodiments, the fraction of the weak base present in its conjugate acid form may be less than about 110%, about 10%, about 20%, about 30%, about 40%, about 50%, about 60%, about 70%, about 80%, or about 90%. In some embodiments, the catholyte and anolyte can be separated by an anion selective barrier that can allow anions such as chloride or nitrate to carry the ionic current from the anolyte to the catholyte.

In some embodiments, the anode compartment can include an anode and an anolyte. In some embodiments, the anolyte can be a liquid or a solution in aqueous form. In some embodiments, the anode can be in contact with the anolyte. In some embodiments, the anode can be submerged in the anolyte. For example, some Figures illustrate anode 5 in anode compartment 3. In some embodiments, the anode compartment can include an anode-containing compartment (e.g., anode-containing compartment 7) that includes the anode and an anolyte compartment (e.g., anolyte compartment 8) that includes the anolyte. In some embodiments, the anode-containing compartment and the anolyte compartment can be separated by an ion or non-ion selective barrier (e.g., ion or non-ion selective barrier 6b). The ion or non-ion selective barrier can be any of those disclosed herein. In some embodiments, the ion or non-ion selective barrier between the anode-containing compartment and the anolyte compartment can prevent the anode-containing compartment from being flooded by the anolyte and/or the anode from being poisoning by the anolyte. For example, the anode-containing compartment can be configured to receive a gas (e.g., hydrogen gas) and the barrier can prevent flooding of the gas anode-containing compartment. In some embodiments, the anode in the anode-containing compartment is adjacent to or in direct contact with the ion or non-ion selective barrier between the anode-containing compartment and the anolyte compartment.

In some embodiments, the anode may be a hydrogen depolarized anode. In some embodiments, the anode can be one similar to that found in a proton-exchange membrane (PEM) fuel cell. In some embodiments, for example, the anode can oxidize hydrogen produced in the cathode to create acidic species that can convert the salt of the conjugate base of the weak acid (e.g., sodium acetate) to the weak acid (acetic acid). In some embodiments, the anode can be composed of various porous materials including carbon paper, carbon felt, graphite paper, graphite felt, titanium fabric, titanium felt, and/or other porous materials. In some embodiments, porous anodes can be doped with catalysts including platinum, ruthenium, nickel, or combinations thereof.

In some embodiments, the depolarized anode may optionally be separated from the anolyte solution by a membrane, ion-selective membrane, coating, or other barrier to prevent flooding of the gas compartment and poisoning of the anode catalyst by the constituents of the anolyte, as described above. In some embodiments, instead of a depolarized anode, the anode may support the oxygen evolution reaction (OER) that would generate oxygen that may be used to depolarize a depolarized cathode. In some embodiments, anodes that support the OER can be those that are similar to those used in alkaline electrolyzers or PEM electrolyzers. In some embodiments, the oxygen consumed by the cathode may be in whole, or in part, the oxygen generated by the anode or may be oxygen from another source such as ambient air. In some embodiments, the anode may be either a hydrogen depolarized anode as described above or an electrode that promotes the OER.

In some embodiments, the anode and/or cathode may be depolarized electrodes. Examples of such depolarized electrodes may include oxygen depolarized cathode or hydrogen depolarized anode. Depolarized electrodes can reduce the energy requirement of the cell by eliminating the unnecessary net generation of energy intensive hydrogen gas. Those skilled in the art would understand that depolarized electrodes are also possible with other gases such as a chlorine.

As stated above, at least one of the catholyte or anolyte can act as a pH buffer to prevent significant changes in the pH in the event of the addition or removal of acidic or basic components. Use of a pH buffering anolyte and/or catholyte can enable the low energy consumption because it can prevent or mitigate significant accumulation of hydronium ions (e.g., protons) and/or hydroxide ions in either the catholyte, anolyte, or both. The absence of significant accumulation of hydronium ions and/or hydroxide ions can prevent or mitigate the undesirable back migration of those species without the need to add extra fluid chambers and/or additional ion or non-ion selective barriers. The absence of extra chambers and/or additional barriers can reduce ohmic potential losses. As such, in some embodiments, there may be only one anode compartment and one cathode compartment in the electrolyzer. In some embodiments, the Faradaic efficiency of the electrolyzer can be above about 90%, about 93%, about 95%, about 97%, about 98%, or about 99%. In some embodiments, the Faradaic efficiency of the electrolyzer can be less than 100%.

In some embodiments, the catholyte and the anolyte may have the same or different compositions. In some embodiments, the anolyte can be a portion of the electrolyte adjacent to the anode. In some embodiments, the anode can include an acid. In some embodiments, the anolyte can include a strong acid. In some embodiments, the anolyte can include or be a pH buffer. In some embodiments, the anolyte can have a dissolved component therein that can act as a pH buffer. The pH buffer can keep the pH at a nearly constant value while an amount of acids and/or bases are added to the pH buffer. In some embodiments, the pH buffer can prevent significant changes in the pH of the anolyte in the event of the addition or removal of acidic or basic components.

In some embodiments, the anolyte pH buffer can include a weak acid and a conjugate base of the weak acid. In some embodiments, the weak acid can have a pKa greater than or equal to 1 and less than or equal to 13 or greater than or equal to 1.8 and less than or equal to 12. In some embodiments, the weak acid can include acetic acid, lactic acid, carbonic acid, bicarbonate, carbonates, benzoic acid, bisulfite, bisulfate, monobasic phosphate, dibasic phosphate, tribasic phosphate, citric acid, hydrofluoric acid, oxalic acid, sulfurous acid, etc., or combinations thereof. In some embodiments, the conjugate base can include acetates, citrates, carbonates, bisulfates, monobasic phosphates, dibasic phosphates, tribasic phosphates, oxalates, and/or sulfate salts. For example, in some embodiments, the inlet anolyte to the anode compartment (or anolyte compartment of anode compartment) can include a weak acid (e.g., acetic acid) and a salt of the conjugate base of the weak acid (e.g., sodium acetate). In some embodiments, the anolyte can also include an inert dissociated salt to increase the conductivity of the anolyte. In some embodiments, the inert dissociated salt can include sodium or potassium chloride salts, salts of nitrates, sulfates, perchlorates, etc., and/or combinations thereof. In some embodiments, the anolyte can include other additives such as surfactants, reducing agents, oxidizing agents, anti-microbial agents, etc., or combinations thereof. In some embodiments, the fraction of the weak acid present in its conjugate base form may be greater than about 0%, about 10%, about 20%, about 30%, about 40%, about 50%, about 60%, about 70%, about 80%, or about 90%. In some embodiments, the fraction of the weak acid present in its conjugate base form may be less than about 100%, about 10%, about 20%, about 30%, about 40%, about 50%, about 60%, about 70%, about 80%, or about 90%. In some embodiments, the catholyte and anolyte can be separated by a cation selective barrier that would allow cations such as sodium or potassium to carry the ionic current from the anolyte to the catholyte. In some embodiments, the catholyte and anolyte may be buffered as described above. In some embodiments, the buffering component may be the same in the catholyte and anolyte or different between the two.

In some embodiments, the cathode compartment can be configured to generate a gas. In some embodiments, the gas can include hydrogen gas. In some embodiments, the anode compartment can be configured to receive the gas and oxidize the gas, thereby generating hydronium ions and/or protons. In some embodiments, the anode-containing compartment of the anode compartment can be configured to receive the gas and oxidize the gas, thereby generating hydronium ions and/or protons. In some embodiments, the anode compartment can generate an acid with the hydronium ions and/or protons. In some embodiments, the anolyte compartment of the anode compartment is configured to receive the hydronium ions and/or protons through the ion-selective barrier and generate an acid.

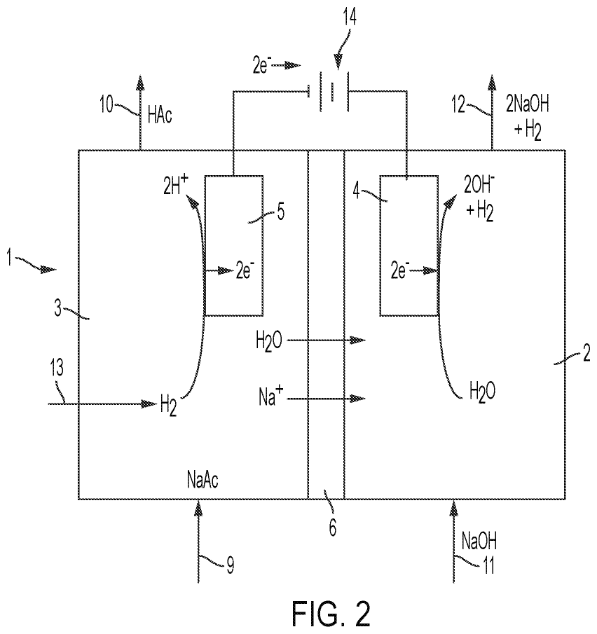

For example, FIGS. 2, 4, and 7 illustrate exemplary electrolyzer diagrams for various example reactions that can occur in the electrolyzer. These figures include at least one anolyte inlet stream 9, at least one catholyte inlet stream 11, at least one anolyte exit stream 10, at least one catholyte exit stream 12, and at least one gas inlet stream 13. As such, in some embodiments, the anode compartment can receive at least one anolyte inlet stream and have at least one anolyte exit stream. In some embodiments, the anolyte compartment of the anode compartment can receive the at least one anolyte inlet stream and have the at least one anolyte exit stream. In other words, the anolyte compartment (and cathode compartment or catholyte compartment) can act as a flow chamber. In some embodiments, the anode compartment can receive the at least one gas inlet stream. In some embodiments, the anode-containing compartment of the anode compartment can receive the at least one gas inlet stream.

As shown in FIGS. 2, 4, and 7, in some embodiments, an oxidation reaction can occur in the anode compartment (e.g., at the anode of the anode compartment) and, in some embodiments, a reduction reaction can occur in the cathode compartment (e.g., at the cathode of the cathode compartment). In some embodiments, the catholyte can be in contact with the cathode directly or through a barrier. In some embodiments, the anolyte can be in contact with the anode directly or through a barrier.

In some embodiments, the cathode compartment can receive at least one catholyte inlet stream and have at least one catholyte exit stream. In some embodiments, the catholyte compartment of the cathode compartment can receive the at least one catholyte inlet stream and have the at least one catholyte exit stream. In other words, the catholyte compartment can act as a flow chamber. In some embodiments, the cathode compartment can receive the at least one gas inlet stream. In some embodiments, the cathode-containing compartment of the cathode compartment can receive the at least one gas inlet stream.

In some embodiments, the at least one anolyte inlet stream can have a higher pH than the at least one anolyte exit stream. In some embodiments, the at least one anolyte exit stream can have a pH of less than 6. In other words, an acid can be generated in the anode compartment such that the anolyte may have a lower pH when it exits the anode compartment. In some embodiments, the at least one catholyte inlet stream can have lower pH than the at least one catholyte exit stream. In some embodiments, the at least one catholyte exit stream can have a pH of greater than 7. In other words, a base can be generated in the cathode compartment such that the catholyte may have a higher pH when it exits the cathode compartment. In some embodiments, the at least one anolyte inlet stream can have a lower pH than the at least one anolyte exit stream and the at least one catholyte inlet stream can have a higher pH than the at least one catholyte exit stream.

In some embodiments, the anode compartment can be configured to generate a gas. In some embodiments, the gas can include oxygen gas. In some embodiments, the cathode compartment can be configured to receive the gas and reduce the gas, thereby generating hydroxide ions. In some embodiments, the cathode-containing compartment of the cathode compartment can be configured to receive the gas and reduce the gas, thereby generating hydroxide ions. In some embodiments, the cathode compartment can generate a base with the hydroxide ions. In some embodiments, the catholyte compartment of the cathode compartment is configured to receive the hydroxide ions through the ion-selective barrier and generate a base.

In some embodiments, a gas (e.g., hydrogen gas) generated in the cathode compartment can be sent to the anode-containing compartment. In some embodiments, gas generated in the cathode compartment can be consumed in the anode compartment. In some embodiments, the gas generated in the cathode compartment can be oxidized in the anode compartment. In some embodiments, the oxidized gas can generate hydronium ions and/or protons. In some embodiments, the hydronium ions and/or protons can be used to generate an acid. In some embodiments, the acid generated can be any of the acids (e.g., strong and/or weak) disclosed herein. In some embodiments, the acid generated can be formed from the hydronium ions and/or protons reacting with the conjugate base of the weak acid in the anolyte. In some embodiments, the acid may be generated in the anolyte compartment after receiving the hydronium ions and/or protons through the barrier between the anolyte compartment and the anode-containing compartment of the anode compartment.

In some embodiments, a gas (e.g., oxygen gas) generated in the anode compartment can be sent to the cathode-containing compartment. In some embodiments, gas generated in the anode compartment can be consumed in the cathode compartment. In some embodiments, the gas generated in the anode compartment can be reduced in the anode compartment. In some embodiments, the reduced gas can generate hydroxide ions. In some embodiments, the hydroxide ions can be used to generate a base. In some embodiments, the base generated can be any of the bases (e.g., strong and/or weak) disclosed herein. In some embodiments, the base generated can form by the hydroxide ions reacting with the conjugate acid of the weak base in the catholyte. In some embodiments, the base may be generated in the catholyte compartment after receiving the hydroxide ions through the barrier between the catholyte compartment and the cathode-containing compartment of the cathode compartment.

Without being limited by any particular theory or interpretation, electrolyzers designed herein may have reduced energy consumption compared to traditional chlor-alkali electrolyzers or other salt splitting electrolyzers because of the reduced voltages required to drive the electrochemical process. For example, the voltage required to drive a chlor-alkali electrolyzer is about 2.2 volts before accounting for overpotentials (also known as the open-circuit potential). In some embodiments, the open-circuit potential can refer to a decomposition voltage, before or without overpotentials. In comparison, in some embodiments, the open-circuit potential to drive an electrolyzer as described herein can be estimated as approximately 70 mV multiplied by the pH difference between the catholyte and anolyte at typical operating temperatures. For example, a system operating with concentrated sodium hydroxide in the catholyte (pH=15) and a mixture of acetic acid and sodium acetate in the anolyte (pH=4.5), the anticipated voltage would be expected to be around 0.74 volts, or one-third of the voltage for a chlor-alkali electrolyzer. In some embodiments, depending on the pH difference between the anolyte and catholyte, the open-circuit potential of the electrolyzers described herein may be less than about 0.2 volts, about 0.5 volts, about 1 volt, or about 2 volts. In some embodiments, the open-circuit potential of the electrolyzers described herein may be more than about 0.001 volts, about 0.05 volts, about 0.1 volts, about 0.2 volts, or about 0.5 volts.

As described above, the pH buffered electrolyzer (i.e., the catholyte and/or anolyte acting as a pH buffer) can significantly reduce undesirable migration of acidic and/or basic streams from crossing between the anolyte and catholyte, thereby increasing the current efficiency of the electrolyzer. The current efficiency can sometimes be referred to as the Faradaic efficiency.

Depending on the choice of buffered electrolyte (e.g., catholyte and/or anolyte), the electrolyzer may have certain further advantages beyond energy consumption in the selectivity of a separation process in comparison to electrolyzers that generate strong acids and bases, such as the chlor-alkali process. For example, as further described herein, a weak acid may selectively dissolve some components of a mineral or ash such as calcium but not significantly dissolve other metals such as iron or aluminum. Similarly, an electrolyzer that generates a weak base such as ammonia or an amine can be able to precipitate some materials, for example magnesium hydroxide, but not other materials, such as calcium hydroxide. For gas scrubbing, depending on the weak base chosen, it might absorb some acid gases, such as sulfur dioxide, but not others, such as carbon dioxide.

In addition, it is well-known that electrolyzers, such as chlor-alkali electrolyzers, are extremely sensitive to certain impurities such as calcium cations. Due to the different pH of the electrolytes and the presence of certain buffering salts, the electrolyzers described herein may be less susceptible to fouling from certain impurities. Similarly, due to the presence of less corrosive electrolytes, the electrolyzers may be less susceptible to corrosion during sudden power shutdowns and/or during power cycling operations. In some embodiments, power cycling may be desirable to operate during periods with cheaper and/or less carbon intensive electricity sources.

In some embodiments, electrolyzers disclosed herein may have lower equipment capital costs than other electrochemical systems for acid and base production such as chlor-alkali electrolyzers. In some embodiments, the electrolyzers disclosed herein may produce weak acids and/or weak bases. In some embodiments, the electrolyzers disclosed herein may produce acids and/or bases at moderate concentrations or moderate pH values, such as bases with pH<14, pH<13, pH<12, pH<11, or pH<10, and/or acids with pH>0, pH>1, pH>2, pH>3, and/or pH>4. In some embodiments, relatively inexpensive materials of construction may be able to prevent electrolyzer corrosion, and/or other forms of degradation or damage. Although chlor-alkali electrolyzer may require expensive, difficult to machine or manufacture metals or alloys such as titanium, titanium alloys, or nickel alloys, may require precious metal coatings over these alloys to prevent oxygen evolution, and may require piping made of costly chlorine-compatible fiber reinforced plastics (FRP), electrolyzers disclosed herein can be made from less expensive, easier to machine/manufacture materials such as carbon steel, stainless steel, graphite, or less expensive plastics (with or without fiber reinforcement), or combinations thereof.

The acids and/or bases generated from the electrolyzers disclosed herein can be used to perform numerous different cyclical processes including dissolution, precipitation, electrodeposition, gas absorption, liquid extraction, solute extraction, reaction catalysis, and/or neutralizations. In some embodiments, once the acid and base are mixed to create a neutralized solution, that solution can be used in whole or in part as a feed to the cathode and/or anode compartments. In some embodiments, the electrolyzers disclosed herein can be used for several electrolyte treatment steps including, but not limited to, precipitation, clarification, filtration, ion- exchange, activated carbon treatment, evaporation, gas stripping, and/or dosing with additive chemicals.

In some embodiments, an acid (e.g., weak or strong acid) anolyte produced by an electrolyzer disclosed herein could be used to dissolve solids (soluble in acid), absorb gases (soluble in acid), extract liquids (soluble in acids), extract solutes (soluble in acids), act as an anti-solvent to precipitate solids, catalyze reactions accelerated by the presence of acid, and/or neutralize the generated base. In some embodiments, the acid anolyte produced by an electrolyzer disclosed herein can be used to neutralize the generated base (e.g., weak or strong base) after the base was used to dissolve solids (soluble in base), absorb gases (soluble in base), extract liquids (soluble in base), extract solutes (soluble in base), act as an anti-solvent to precipitate solids, or catalyze reactions accelerated by the presence of base. In some embodiments, a base (e.g., weak or strong base) catholyte produced by an electrolyzer disclosed herein could be used to dissolve solids (soluble in base), absorb gases (soluble in base), extract liquids (soluble in base), extract solutes (soluble in base), act as an anti-solvent to precipitate solids, catalyze reactions accelerated by the presence of base, and/or neutralize the generated acid. In some embodiments, the base catholyte produced by an electrolyzer disclosed herein can be used to neutralize the generated acid (e.g., weak or strong acid) after the acid was used to dissolve solids (soluble in acid), absorb gases (soluble in acid), extract liquids (soluble in acid), extract solutes (soluble in acid), act as an anti-solvent to precipitate solids, or catalyze reactions accelerated by the presence of acid.

In some embodiments, if the acidic anolyte is used to perform a task it may then neutralized by a base from the catholyte or if the basic catholyte is used to perform a task it may then be neutralized by the acid anolyte. In some embodiments, the neutralized mixture can then be used in whole or in part as the feed to the cathode compartment and/or anode compartment (e.g., the at least one catholyte inlet stream and/or the at least one anolyte inlet stream).

Some embodiments disclosed herein may allow for the dissolution of metal oxides from limestone (high calcium, dolomitic, or magnesian), dolomite, calcite, aragonite, wollastonite, fly ashes, bottom ashes, pond ash, blast furnace slag, blast oxygen furnace slag, electric arc furnace slag, slag from municipal waste, olivine, and/or other similar sources such as waste products and mined rocks.

Some embodiments disclosed herein can involve an electrolyzer with a weak acid carbonate or bicarbonate anolyte and strong base catholyte that can be used for capture of carbon dioxide from dilute streams including ambient air. In some embodiments, strong base can be contacted with a flowing gas stream of air to create a weak acid solution of carbonate and bicarbonate. The carbonate/bicarbonate can then supplied, in part or in whole, as the anolyte stream of the weak acid electrolyzer. As the anolyte is acidified, the bicarbonate and carbonate can be converted to carbonic acid, which can lead to the evolution of carbon dioxide that can be captured as a near pure stream for sequestration or utilization by means well-known to those skilled in the art. The decarbonated anolyte can then be sent back to the cathode compartment where it can form the at least one catholyte inlet stream, in part or in total, to be converted back into a strong base. In some embodiments, some buffered electrolytes (anolytes and/or catholytes) suitable for use in the invention in the anolyte, catholyte, or both can be composed of dissolved forms gases (carbon dioxide, sulfur dioxide, ammonia, chlorine, etc.) that can become absorbed and evaporate or could be similarly dissolved forms of solids that can dissolve and precipitate. Other buffered electrolytes can be soluble in the anolyte and/or catholyte but unlikely to vaporize or precipitate such as salts of acetates, citrates, ethanolamines, phenols, benzoates, chlorates, hypochlorites, and/or phosphates.

Similar to the above example with carbon dioxide, some embodiments disclosed herein can include the regeneration of desulfurization absorbents such as lime, limestone, and/or amines through the acidification of the spent absorbent in the anode compartment and/or by contacting with the anolyte to release the capture sulfur as sulfur dioxide and then regeneration of the desulfurized absorbent in the cathode compartment.

In some embodiments, the reactor(s) or electrolyzer(s) can be operated using intermittent renewable electricity. In some embodiments, the acid and/or base streams produced by the electrolyzers can be stored for later use. In some embodiments, electricity can be used at times of low cost to operate the reactor and produce acids and/or bases, which can be stored and used to operate the chemical dissolution and precipitation processes at times of high electricity cost.

In some embodiments, a method disclosed herein can include dissolving a feedstock material comprising a target element and precipitating (and/or electrodepositing) the target element from the feedstock material. In some embodiments, the feedstock material can be dissolved using an acid and/or base generated by an electrolyzer disclosed herein. In some embodiments, the acid and/or base can be in the anolyte and/or catholyte from an electrolyzer disclosed herein. In some embodiments, the target element can be precipitated (and/or electrodeposited) from the dissolved feedstock material using an acid and/or base generated by an electrolyzer disclosed herein. In some embodiments the acid and/or base can be in the anolyte and/or catholyte from an electrolyzer disclosed herein.

In some embodiments, a feedstock material can be a calcium salt such as calcium carbonate (e.g., CaCO₃), calcium silicates (e.g., CaSiO₃), calcium aluminosilicates, slags, ashes, recycled concrete, returned concrete, minerals, etc., and/or combinations thereof. In some embodiments, the target material can be calcium (to form calcium hydroxide), magnesium (to form magnesium hydroxide), high value metals (e.g., nickel, copper, or manganese), and/or silica. In some embodiments, two or more products can be produced based on separating the insoluble material and selectively precipitating and/or electrowinning multiple dissolved compounds.

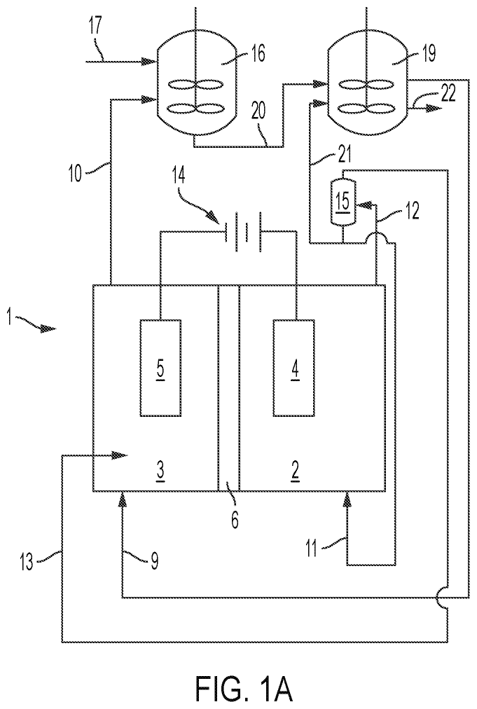

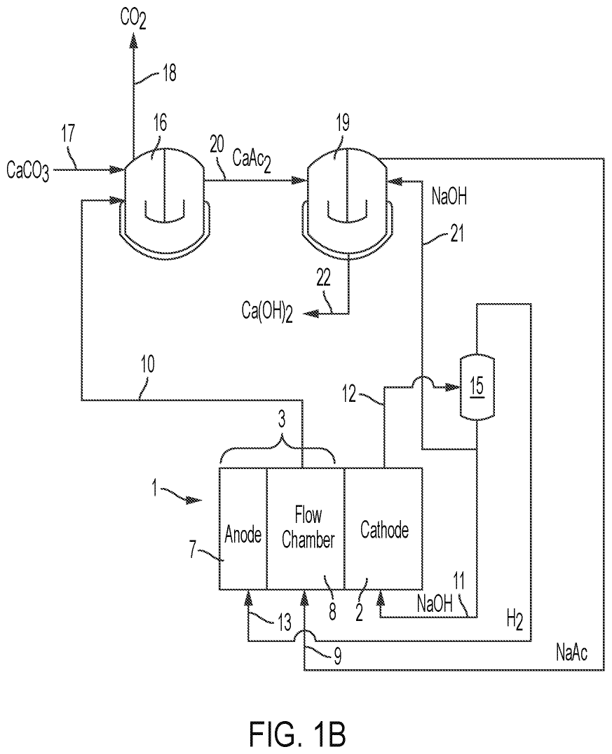

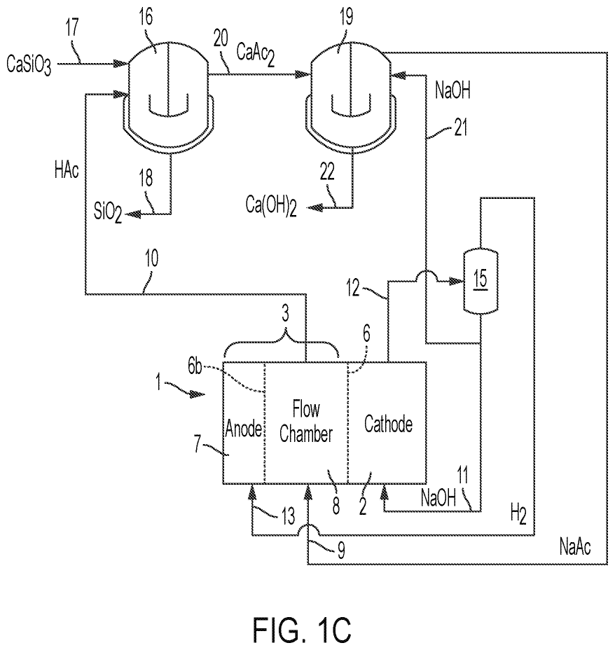

FIGS. 1A-1C can illustrate a system for the dissolution and precipitation of a feedstock material using the electrolyzers disclosed herein in accordance with some embodiments. In some embodiments, FIG. 2 illustrates an electrolyzer diagram showing example reactions that can be used in the dissolution and precipitation of the feedstock material. In some embodiments, electrolyzer 1 can include an anode 5 (e.g., depolarized anode) in anode-containing compartment 7 of anode compartment 3. In some embodiments, the anode can be separated from an anolyte compartment 8 (e.g., a flow chamber) via a barrier 6b (e.g., cation-selective membrane). In some embodiments, the anolyte compartment includes an anolyte comprising a weak acid (e.g., acetic acid) and its conjugate base (e.g., sodium acetate). In some embodiments, the anode compartment is separated from the cathode compartment 2 via a barrier 6 (e.g., cation-selective membrane). In some embodiments, the cathode compartment includes a catholyte comprising a base (e.g., sodium hydroxide) and cathode 4. In some embodiments, the cathode compartment can support a gas generation reaction (e.g., hydrogen evolution reaction). In some embodiments, the electrolyzer can include a power supply (e.g., power supply 14) that can provide power to the electrolyzer.

In some embodiments, a gas generated by the reaction at the cathode can leave the electrolyzer with the at least one catholyte exit stream 12 (i.e., catholyte product stream). In some embodiments, a system can include a gas/liquid separator 15 configured to separate a gas from a liquid. In some embodiments, the gas/liquid separator can be configured to receive the at least one catholyte exit stream and separate the gas (e.g., hydrogen gas) from the catholyte (e.g., sodium hydroxide). In some embodiments, the separated gas (e.g., at least one gas inlet stream 13) from the catholyte exit stream can be sent to the anode compartment (e.g., anode-containing compartment). In some embodiments, the gas can be sent to the anode compartment (anolyte compartment if no anode-containing compartment) such that it is bubbled into the anode compartment. In some embodiments, the separated gas (e.g., hydrogen) can be oxidized by the anode generating hydronium ions and/or protons. In some embodiments, these hydronium ions and/or protons can transfer through the barrier 6b separating the anode-containing compartment and the anolyte compartment. In some embodiments, the hydronium ions and/or protons can react with the anolyte (e.g., the conjugate base of the anolyte (e.g., sodium acetate)) to form an acid (e.g., acetic acid). In some embodiments, the at least one anolyte exit stream 10 can include a lower pH than the at least one anolyte inlet stream 9. In some embodiments, the at least one anolyte exit stream 10 can include the weak acid (e.g., acetic acid) with a lesser amount of residual conjugate base (e.g., sodium acetate) than the at least one anolyte inlet stream. In some embodiments, the cathode compartment can be configured to receive at least a portion of the separated catholyte from the gas/liquid separator as the at least one catholyte inlet stream 11.

In some embodiments, a system can include at least one dissolution reactor 16. In some embodiments, a feedstock material 17 comprising a target element can be dissolved in the at least one dissolution reactor. In some embodiments, the at least one anolyte exit stream can be mixed with the feedstock material in the at least one dissolution reactor. In some embodiments, the at least one dissolution reactor can be configured to receive the feedstock material and the at least one anolyte exit stream (i.e., anolyte product stream). In some embodiments, at least a portion the feedstock material (e.g., at least the target material) can be dissolved (e.g., dissolving calcium into calcium acetate) by the anolyte exit stream (e.g., acetic acid) in the at least one dissolution reactor. In some embodiments, an acid generated in the anode compartment can be used to dissolve at least a portion of the feedstock material. In some embodiments, during the dissolution process, some products may be removed in waste stream 18. For example, if the feedstock material is carbonated (e.g., calcium carbonate), carbon dioxide may form during dissolution and may exit in the waste stream. In some embodiments, if the feedstock material includes silicon, a silicon oxide (e.g., silicon dioxide) may form during dissolution and can exit in the waste stream.

In some embodiments, a system can include at least one precipitation reactor 19. In some embodiments, a portion of the dissolved feedstock material 20 (e.g., the dissolved target material) can be sent to the at least one precipitation reactor. In some embodiments, the at least one precipitation reactor can precipitate a component of the dissolved feedstock material. In some embodiments, the at least one precipitation reactor can be configured to receive a portion of the separated catholyte 21 (e.g., sodium hydroxide) and precipitate a target element from the dissolved feedstock material. In some embodiments, the at least one precipitation reactor is configured to receive a portion of the separated catholyte from the gas/liquid separator. In some embodiments, the portion of the separated catholyte (e.g., sodium hydroxide) from the gas/liquid separator can mix with the dissolved feedstock material (e.g., calcium acetate) to precipitate a target material (e.g., calcium hydroxide). As stated above, a portion of the separated catholyte from the gas/liquid separator can be recycled back as the at least one catholyte inlet stream of the cathode compartment. In some embodiments, the reaction between the separated catholyte (e.g., sodium hydroxide) and the dissolved feedstock material (e.g., calcium acetate) can precipitate a target material 22 (e.g., calcium in the form of calcium hydroxide), which can be removed as a slurry in some embodiments. In some embodiments, the overflow of the at least one precipitation reactor can be sent to the anode compartment to be used as the at least one anolyte inlet stream. In some embodiments, depending on the salt dissolved, various solids may be recovered as the target material such as silica.

Although the above description describes a gas being generated in the cathode compartment and oxidized in the anode compartment with the dissolution being accomplished with an acid formed in the anode compartment, in some embodiments, the system can be utilized with a gas being generated in the anode compartment (e.g., oxygen) and reduced in the cathode compartment with the dissolution being accomplished with a base formed in the cathode compartment (and precipitation reaction caused by an acid from the anode compartment). In other words, the systems described with respect to the figures can equally be applied to a base dissolution and acid precipitation reaction with a gas/liquid separator fluidically connected to the anode compartment. As such, the at least one dissolution reactor can be fluidically connected to the anode compartment (or anolyte compartment) and/or the cathode compartment (or catholyte compartment), the at least one precipitation reactor can be fluidically connected to the anode compartment (or anolyte compartment) and/or the cathode compartment (or catholyte compartment), the gas/liquid separator can be fluidically connected to the anode compartment (or anolyte compartment or anode-containing compartment) and/or the cathode compartment (or catholyte compartment or cathode-containing compartment), and/or the at least one precipitation reactor can be fluidically connected to the gas/liquid separator.

In some embodiments, a method disclosed herein can include capturing a gas (e.g., an acid gas) from a gas mixture. In other words, the methods disclosed herein can include a gas separation process (e.g., a carbon dioxide gas separation process). In some embodiments, the acid gas can be carbon dioxide, sulfur dioxide, and/or hydrogen sulfide. In some embodiments, the gas mixture can be air (e.g., ambient air), post-combustion gases, natural gas and/or other hydrocarbon vapors. In some embodiments, the gas can be a basic gas such as ammonia and/or methylamine.

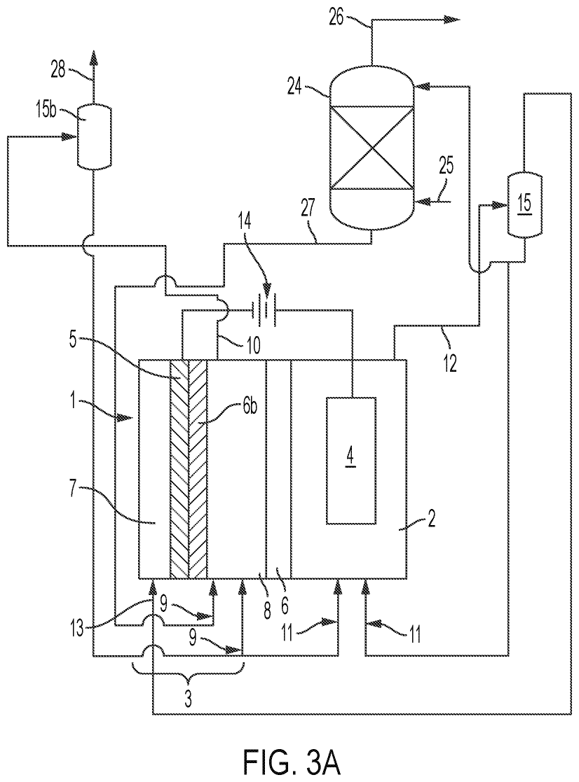

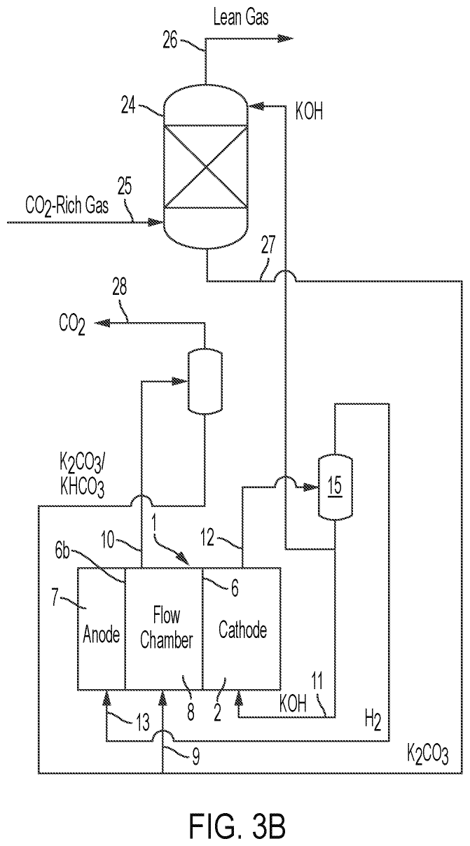

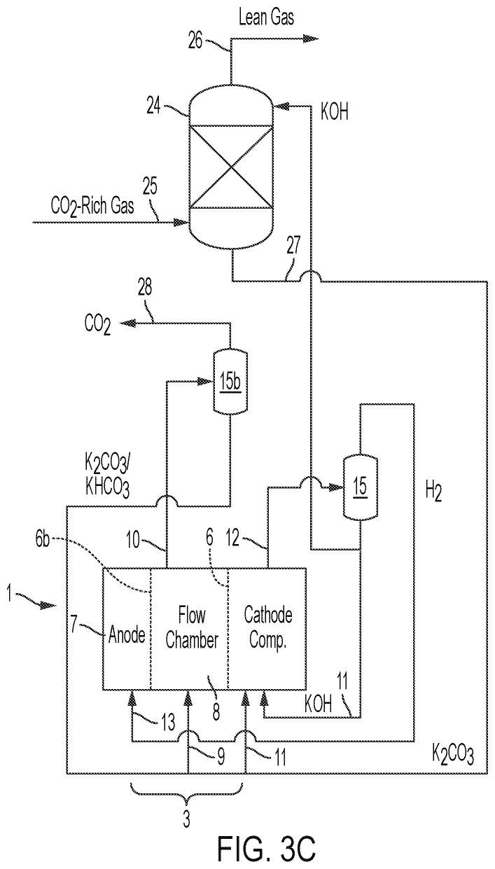

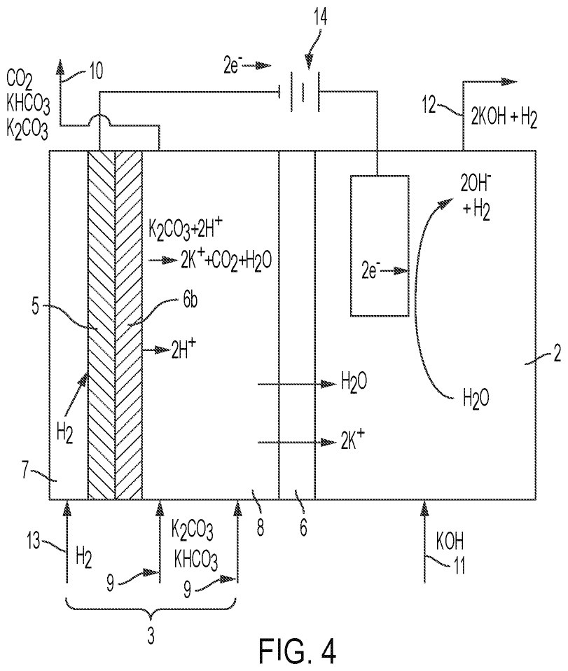

FIGS. 3A-3C can illustrate a system for a gas separation process using the electrolyzers disclosed herein in accordance with some embodiments. In some embodiments, FIG. 4 illustrates an electrolyzer diagram showing examples reactions that can be used in the gas separation process. In some embodiments, electrolyzer 1 can include an anolyte compartment 8 that includes an anolyte (e.g., aqueous potassium bicarbonate) separated from an anode-containing compartment 7 by a barrier 6b (e.g., cation-selective membrane). In some embodiments, the anolyte can include a weak acid (e.g., potassium bicarbonate) and its conjugate base (e.g., potassium carbonate). In some embodiments, the anode-containing compartment 8 can include an anode 5 (e.g., a porous platinum-containing carbon anode). In some embodiments, the anode compartment 3 can be separated from the cathode compartment 2 via a barrier 6 (e.g., cation-selective membrane). In some embodiments, the cathode compartment can include a catholyte comprising a base (e.g., potassium hydroxide) and (in contact with) a cathode 4 (e.g., porous nickel cathode) (that can support an HER reaction). In some embodiments, power supply 14 can supply power to the electrolyzer.

In some embodiments, a gas generated by the reaction at the cathode can leave the electrolyzer with the at least one catholyte exit stream 12 (i.e., catholyte product stream). In some embodiments, a system can include a gas/liquid separator 15 configured to separate a gas from a liquid. In some embodiments, the gas/liquid separator can be configured to receive the at least one catholyte exit stream and separate the gas (e.g., hydrogen gas) from the catholyte (e.g., potassium hydroxide). In some embodiments, the separated gas (e.g., at least one gas inlet stream 13) from the catholyte exit stream can be sent to the anode compartment (e.g., anode-containing compartment). In some embodiments, the gas can be sent to the anode compartment (anolyte compartment if no anode-containing compartment) such that it is bubbled into the anode compartment. In some embodiments, the separated gas (e.g., hydrogen) can be oxidized by the anode generating hydronium ions and/or protons. In some embodiments, these hydronium ions and/or protons can transfer through the barrier 6b separating the anode-containing compartment and the anolyte compartment. In some embodiments, the hydronium ions and/or protons can react with the anolyte (e.g., the conjugate base of the anolyte (e.g., potassium carbonate)) to form an acid (e.g., potassium bicarbonate). In some embodiments, the at least one anolyte exit stream 10 can include a lower pH than the at least one anolyte inlet stream 9. In some embodiments, the at least one anolyte exit stream 10 can include the weak acid (e.g., potassium bicarbonate) with a lesser amount of residual conjugate base (e.g., potassium carbonate) compared to the at least one anolyte inlet stream. In some embodiments, the cathode compartment can be configured to receive at least a portion of the separated catholyte from the gas/liquid separator as the at least one catholyte inlet stream 11.

In some embodiments, a system can include at least one gas absorber 24 (e.g., a packed bed absorber column) configured to receive a gas mixture 25 (e.g., air, flue gas, exhaust gas, CO₂-rich gas, etc.). In some embodiments, the gas absorber can remove a target gas (e.g., an acid gas) from a gas mixture. In some embodiments, the gas absorber can capture the gas (e.g., an acid gas) in a liquid. In some embodiments, the at least one gas absorber can be configured to receive a portion of the separated catholyte (e.g., potassium hydroxide) from the gas/liquid separator. In some embodiments, the at least one gas absorber can be configured to capture the acid gas in the separated catholyte from the gas/liquid separator. In some embodiments, the portion of the separated catholyte from the gas/liquid separator can be sent to the top of the absorber, where it counter-currently contacts a gas mixture (e.g., a carbon dioxide containing gas stream such as air or an industrial process gas). The cleaned gas or lean gas 26 with the majority of the target gas (e.g., carbon dioxide) removed can exit the absorber. In some embodiments, the catholyte in the absorber can capture the target gas. For example, potassium hydroxide can become carbonated forming a mix of residual potassium hydroxide, potassium carbonate, and potassium bicarbonate.

In some embodiments, the captured target gas stream 27 can be sent to the anode compartment (the anolyte compartment of the anode compartment) and/or cathode compartment. In some embodiments, the captured target gas stream can be one of the anolyte inlet streams 9. As stated above, in some embodiments, the separated gas (e.g., hydrogen) can be oxidized by the anode generating hydronium ions and/or protons. In some embodiments, these hydronium ions and/or protons can transfer through the barrier 6b separating the anode-containing compartment and the anolyte compartment. In some embodiments, the anode compartment (or the anolyte compartment of the anode compartment) can be configured to generate a gas (e.g., an acid gas). In some embodiments, the hydronium ions and/or protons can react (e.g., acidify) with the anolyte, thereby releasing a gas (e.g., carbon dioxide) from the anolyte.

In some embodiments, a gas generated in the anolyte can leave the electrolyzer with the at least one anolyte exit stream 10. In some embodiments, a system can include another gas/liquid separator 15b configured to separate a gas from a liquid. In some embodiments, the gas/liquid separator can be configured to receive the at least one anolyte exit stream and separate the gas (e.g., acid gas such as carbon dioxide) from the anolyte (e.g., potassium bicarbonate, potassium carbonate, and/or inert electrolyte such as sodium/potassium chloride). In some embodiments, the separated gas 28 (e.g., acid gas) from the anolyte exit stream can be sent for purification, compression, storage, and/or utilization. In some embodiments, the cathode compartment and/or anode compartment can be configured to receive at least a portion of the separated anolyte from the gas/liquid separator as the at least one anolyte inlet stream 9 and/or the at least one catholyte inlet stream 11.

In some embodiments, any of the gas/liquid separators can be fluidically connected to the anode compartment (or anolyte compartment or anode-containing compartment) and/or the cathode compartment (or catholyte compartment or cathode-containing compartment). In some embodiments, the gas absorber can be fluidly connected to a gas/liquid separator, a cathode compartment (or catholyte compartment or cathode-containing compartment), and/or the anode compartment (or anolyte compartment or anode-containing compartment).

As stated above, in some embodiments, a method disclosed herein can include dissolving a feedstock material comprising a target element and precipitating (and/or electrodepositing) the target element from the feedstock material. In some embodiments, the feedstock material can be dissolved using an acid and/or base generated by an electrolyzer disclosed herein. In some embodiments, the acid and/or base can be in the anolyte and/or catholyte from an electrolyzer disclosed herein. In some embodiments, the target element can be precipitated (and/or electrodeposited) from the dissolved feedstock material using an acid and/or base generated by an electrolyzer disclosed herein. In some embodiments the acid and/or base can be in the anolyte and/or catholyte from an electrolyzer disclosed herein.

In some embodiments, a feedstock material can be a metal ore such as a copper ore, nickel ore, olivine, slags, ashes, laterites, and/or combinations thereof. In some embodiments, the metal ore can include copper, nickel, iron, manganese, calcium, aluminum, magnesium, silicon, and/or combinations thereof. In some embodiments, the target material can be a metal such as nickel, copper, or combinations thereof in the metal ore.

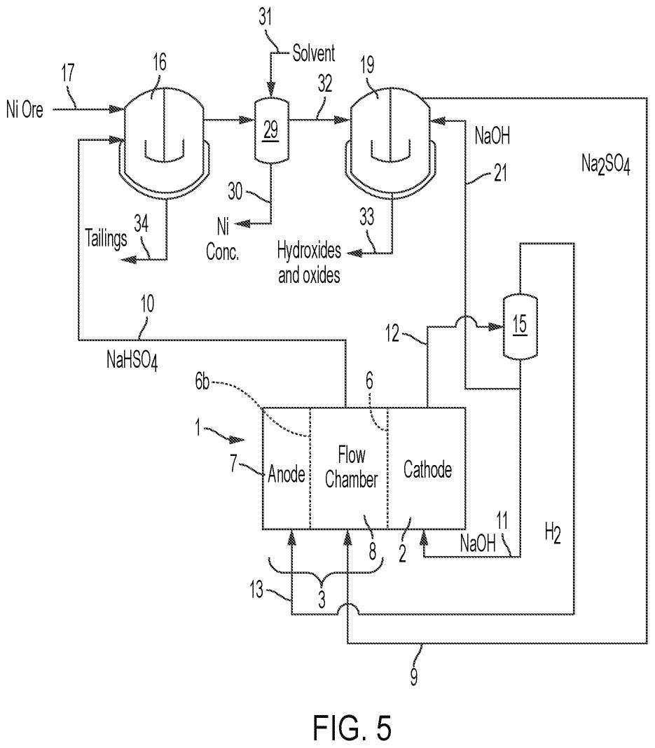

FIG. 5 illustrates a system for a metal leaching process using the electrolyzers disclosed herein in accordance with some embodiments. In some embodiments, electrolyzer 1 can include an anode (e.g., depolarized anode) in anode-containing compartment 7 of anode compartment 3. In some embodiments, the anode can be separated from an anolyte compartment 8 (e.g., a flow chamber) via a barrier 6b (e.g., cation-selective membrane). In some embodiments, the anolyte compartment includes an anolyte comprising a weak acid (e.g., sodium bisulfate) and its conjugate base (e.g., sodium sulfate). In some embodiments, the anode compartment is separated from the cathode compartment 2 via a barrier 6 (e.g., cation-selective membrane). In some embodiments, the cathode compartment includes a catholyte comprising a base (e.g., sodium hydroxide) and cathode 4. In some embodiments, the cathode compartment can support a gas generation reaction (e.g., hydrogen evolution reaction). In some embodiments, the electrolyzer can include a power supply that can provide power to the electrolyzer.

In some embodiments, a gas generated by the reaction at the cathode can leave the electrolyzer with the at least one catholyte exit stream 12 (i.e., catholyte product stream). In some embodiments, a system can include a gas/liquid separator 15 configured to separate a gas from a liquid. In some embodiments, the gas/liquid separator can be configured to receive the at least one catholyte exit stream and separate the gas (e.g., hydrogen gas) from the catholyte (e.g., sodium hydroxide). In some embodiments, the separated gas (e.g., at least one gas inlet stream 13) from the catholyte exit stream can be sent to the anode compartment (e.g., anode-containing compartment). In some embodiments, the gas can be sent to the anode compartment (anolyte compartment if no anode-containing compartment) such that it is bubbled into the anode compartment. In some embodiments, the separated gas (e.g., hydrogen) can be oxidized by the anode generating hydronium ions and/or protons. In some embodiments, these hydronium ions and/or protons can transfer through the barrier 6b separating the anode-containing compartment and the anolyte compartment. In some embodiments, the hydronium ions and/or protons can react with the anolyte (e.g., the conjugate base of the anolyte (e.g., sodium sulfate)) to form an acid (e.g., sodium bisulfate). In some embodiments, the at least one anolyte exit stream 10 can include a lower pH than the at least one anolyte inlet stream. In some embodiments, the at least one anolyte exit stream 10 can include the weak acid (e.g., sodium bisulfate) with a lesser amount of residual conjugate base (e.g., sodium sulfate) (and potentially a small amount of sulfuric acid compared to the at least one anolyte inlet stream. In some embodiments, the cathode compartment can be configured to receive at least a portion of the separated catholyte (e.g., sodium hydroxide) from the gas/liquid separator as the at least one catholyte inlet stream 11.

In some embodiments, a system can include at least one dissolution reactor 16. In some embodiments, a feedstock material 17 comprising a target element can be dissolved in the at least one dissolution reactor. In some embodiments, the at least one anolyte exit stream can be mixed with the feedstock material in the at least one dissolution reactor. In some embodiments, the at least one dissolution reactor can be configured to receive the feedstock material and the at least one anolyte exit stream (i.e., anolyte product stream). In some embodiments, at least a portion the feedstock material (e.g., at least the target material) can be dissolved (e.g., dissolving the metal (nickel, copper, or combinations thereof)) by the anolyte exit stream (e.g., bisulfate acid) in the at least one dissolution reactor. In some embodiments, an acid generated in the anode compartment can be used to dissolve at least a portion of the feedstock material. For example, in some embodiments, the anolyte exit stream can leach the target element from the feedstock material as a dissolved metal salt (e.g., dissolved sulfate salt).

In some embodiments, the dissolved feedstock material (including the dissolved target material (e.g., dissolved metal salt), can be processed by a solvent extractor and/or electrodepositor 29. In some embodiments, the sulfate salt can be processed by means known in the art such as solvent extraction (using a solvent stream 31) and/or electrodeposition to concentrate the target element (e.g., target metal nickel, copper, or combinations thereof) into target stream 30

In some embodiments, a system can include at least one precipitation reactor 19. In some embodiments, a remaining lean solution 32 with the target material or a majority thereof removed can be sent to the at least one precipitation reactor. In some embodiments, the at least one precipitation reactor can precipitate a component of the remaining lean solution. In some embodiments, the at least one precipitation reactor can be configured to receive a portion of the separated catholyte 21 (e.g., sodium hydroxide) and precipitate materials (e.g., hydroxides and/or oxides) from the remaining lean solution. In some embodiments, the at least one precipitation reactor is configured to receive a portion of the separated catholyte from the gas/liquid separator. In some embodiments, the portion of the separated catholyte (e.g., sodium hydroxide) from the gas/liquid separator can mix with the remaining lean solution to precipitate materials (e.g., hydroxides and/or oxides). As stated above, a portion of the separated catholyte from the gas/liquid separator can be recycled back as the at least one catholyte inlet stream of the cathode compartment. In some embodiments, the reaction between the separated catholyte (e.g., sodium hydroxide) and the remaining lean solution (e.g., sulfate salts of iron, calcium, aluminum, magnesium, etc.) can precipitate materials 33 (e.g., hydroxide and oxides of the metals), which can be removed as a slurry in some embodiments. In some embodiments, the overflow (e.g., sodium sulfate) of the at least one precipitation reactor can be sent to the anode compartment to be used as the at least one anolyte inlet stream. In some embodiments, depending on the salt dissolved, various tailings solids 34 may be recovered from the at least one dissolution reactor.

In some embodiments, the at least one dissolution reactor can be fluidically connected to the anode compartment (or anolyte compartment) and/or the cathode compartment (or catholyte compartment), the at least one precipitation reactor can be fluidically connected to the anode compartment (or anolyte compartment) and/or the cathode compartment (or catholyte compartment), the gas/liquid separator can be fluidically connected to the anode compartment (or anolyte compartment or anode-containing compartment) and/or the cathode compartment (or catholyte compartment or cathode-containing compartment), and/or the at least one precipitation reactor can be fluidically connected to the gas/liquid separator. In some embodiments, the solvent extractor and/or electrodepositor can be fluidically connected to the at least one dissolution reactor and/or the at least one precipitation reactor.

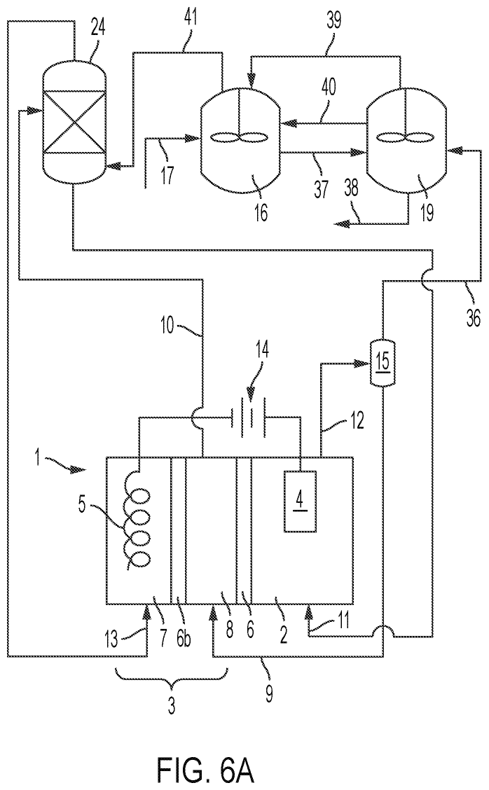

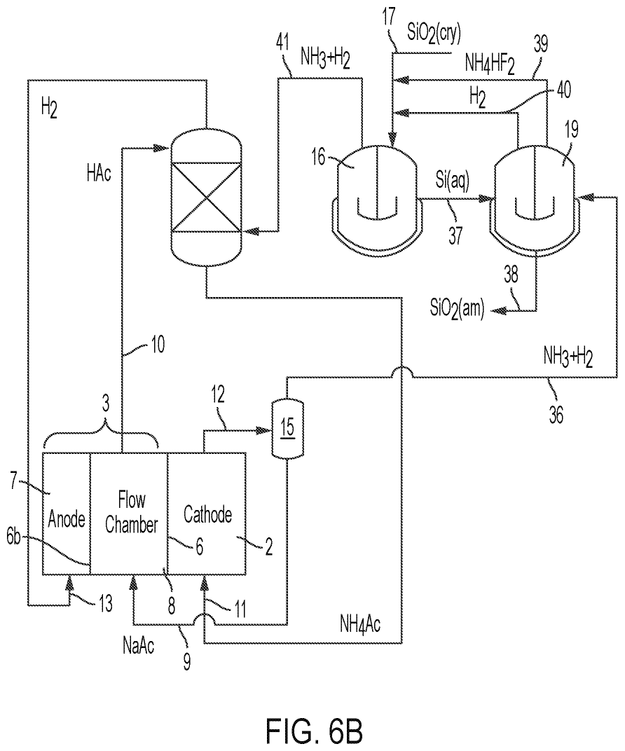

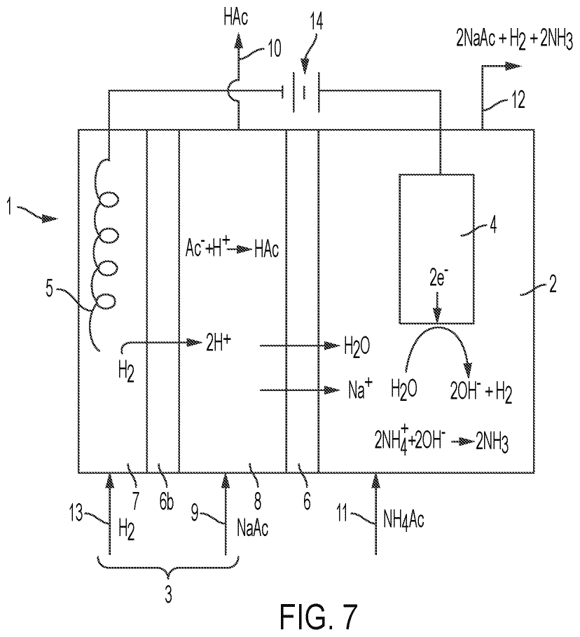

In some embodiments, a feedstock material can be a silicon-containing material such as silicon oxide (e.g., silica/silicon dioxide). In some embodiments, the feedstock material can be silica with high crystallinity. FIGS. 6A-6B can illustrate a system for a silica leaching or silica upgrading process using the electrolyzers disclosed herein in accordance with some embodiments. In some embodiments, FIG. 7 illustrates an electrolyzer diagram showing example reactions that can be used in the silica leaching or silica upgrading process. In some embodiments, electrolyzer 1 can include an anode (e.g., porous anode) in anode-containing compartment 7 of anode compartment 3. In some embodiments, the anode can be separated from an anolyte compartment 8 (e.g., a flow chamber) via a barrier 6b (e.g., cation-selective membrane). In some embodiments, the anolyte compartment includes an anolyte comprising a weak acid (e.g., acetic acid) and its conjugate base (e.g., sodium acetate). In some embodiments, the anolyte compartment includes just a conjugate base of a weak acid (e.g., sodium acetate). In some embodiments, the anode compartment is separated from the cathode compartment 2 via a barrier 6 (e.g., cation-selective membrane). In some embodiments, the cathode compartment includes a catholyte comprising a base (e.g., ammonium acetate) and cathode 4. In some embodiments, a power supply 14 can drive electrons from the anode to the cathode. In some embodiments, the cathode compartment can support a gas generation reaction (e.g., hydrogen evolution reaction). In some embodiments, the cathode compartment can be configured to generate a second gas (e.g., ammonia). For example, in some embodiments, at the cathode, a base can be released causing the aqueous ammonium cations to deprotonate and become volatile ammonia that forms a gas phase along with the hydrogen.

In some embodiments, a gas or gases (e.g., hydrogen and/or ammonia) generated by the reaction at the cathode can leave the electrolyzer with the at least one catholyte exit stream 12 (i.e., catholyte product stream). In some embodiments, a system can include a gas/liquid separator 15 configured to separate a gas or gases from a liquid. In some embodiments, the gas/liquid separator can be configured to receive the at least one catholyte exit stream and separate the gas (e.g., hydrogen gas and/or ammonia) from the reacted catholyte (e.g., sodium acetate solution). In some embodiments, the anode compartment (e.g., the anolyte compartment) can be configured to receive the separated reacted catholyte (e.g., sodium acetate) from the gas/liquid separator as the at least one anolyte inlet stream 9.

In some embodiments, the separated gas 36 from the gas/liquid separator can be sent to the at least one precipitation reactor 19. In some embodiments, the separated gas (e.g., hydrogen and/or ammonia) can enter the precipitation reactor where it can be contacted with a solubilized silicon fluoride complex stream 37 (that contains solubilized silicon fluoride complexes). In some embodiments, when contacted with a portion of the separated gas (e.g., ammonia), the silica can precipitate and can be removed in silica product stream (e.g., amorphous silica) 38. In some embodiments, the solution of the precipitator (e.g., NH₄HF₂) can exit the precipitation reactor as stream 39 with remaining gas stream 40 (e.g., mostly hydrogen gas) and sent to a dissolution reactor 16. In some embodiments, a feedstock material 17 (e.g., silica with high crystallinity) can be dissolved in the at least one dissolution reactor. In the dissolution reactor, the remaining gas stream 40 (e.g., mostly hydrogen gas) can strip ammonia from the dissolution reactor, which can aid in the dissolution. The combined gas stream 41 (e.g., hydrogen and ammonia) can exit the dissolution reactor and proceed to gas absorber 24 (e.g., a packed bed absorber column). In some embodiments, the gas absorber can be configured to receive the combined gas stream and can be configured to remove a target gas (e.g., ammonia) from the combined gas stream. In some embodiments, the gas absorber can capture the gas (e.g., ammonia) in a liquid. In some embodiments, the at least one gas absorber can be configured to receive the anolyte exit stream (e.g., acetic acid (with some sodium acetate)). In some embodiments, the gas absorber can be configured to capture the target gas in the anolyte exit stream. In some embodiments, the anolyte exit stream can be sent to the top of the absorber, where it counter-currently contacts the combined gas stream (e.g., ammonia and hydrogen gas). The cleaned gas or lean gas (e.g., hydrogen) with the majority of the target gas (e.g., ammonia) removed can exit the absorber. In some embodiments, the anolyte in the absorber can capture the target gas. For example, loaded ammonium acetate solution can exit the gas absorber to sent to the cathode compartment (to be the catholyte inlet stream 11).

In some embodiments, the cleaned gas or lean gas can be sent to the anode compartment (e.g., anode-containing compartment). In some embodiments, the gas can be sent to the anode compartment (anolyte compartment if no anode-containing compartment) such that it is bubbled into the anode compartment. In some embodiments, the cleaned gas or lean gas (e.g., hydrogen) can be oxidized by the anode generating hydronium ions and/or protons. In some embodiments, these hydronium ions and/or protons can transfer through the barrier 6b separating the anode-containing compartment and the anolyte compartment. In some embodiments, the hydronium ions and/or protons can react with the anolyte (e.g., the conjugate base of the anolyte (e.g., sodium acetate)) to form an acid (e.g., acetic acid). In some embodiments, the at least one anolyte exit stream 10 can include a lower pH than the at least one anolyte inlet stream 9. In some embodiments, the at least one anolyte exit stream 10 can include the weak acid (e.g., acetic acid) with a lesser amount of residual conjugate base (e.g., sodium acetate) compared to the at least one anolyte inlet stream.

In some embodiments, the at least one precipitation reactor can be fluidically connected to the anode compartment (or anolyte compartment) and/or the cathode compartment (or catholyte compartment). In some embodiments, the at least one gas absorber can be fluidically connected to the anode compartment (or anode-containing compartment) and/or the cathode compartment (or catholyte compartment). In some embodiments, the gas/liquid separator can be fluidically connected to the cathode compartment (or catholyte compartment) and/or a precipitation reactor. In some embodiments, a dissolution reactor can be fluidically connected to a precipitation reactor and/or a gas absorber.

### EXAMPLES

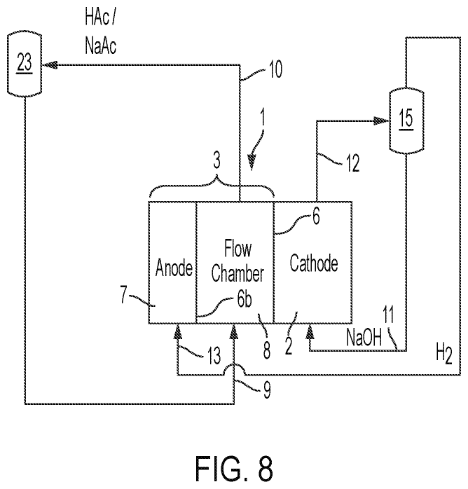

FIG. 8 illustrates an exemplary setup tested in a laboratory setting to simulate the performance of the electrolyzer described in a calcium leaching embodiment. Electrolyzer 1 includes a depolarized anode in an anode-containing compartment 7 supplied with hydrogen 13 separated from an anolyte compartment 8 by a cation exchange membrane 6b. The anolyte in the anolyte compartment 8 is a sodium acetate and acetic acid anolyte. The anolyte is further in contact with a cation-selective membrane 6. On the opposite side of this membrane, is the sodium hydroxide cathode compartment 2 containing the catholyte and cathode that can support HER. The hydrogen generated by the reaction at the cathode can leaves the electrolyzer with the catholyte exit stream 12 and enters the gas/liquid separator 15. The hydrogen gas 13 can exit the gas/liquid separator and be injected into the anode compartment 3 (specifically, the anode-containing compartment 7). The hydrogen gas can be oxidized at the hydrogen depolarized anode generating protons that can react with the sodium acetate in the anolyte to form acetic acid. As a result, the anolyte exiting the electrolyzer in stream 10 contains acetic acid with sodium acetate and is held in reservoir 23. In this electrolyzer test setup, the acid can be recirculated back to the electrolyzer from the reservoir as stream 9 where the sodium acetate can further be converted to acetic acid. The sodium hydroxide stream 11 that exits gas/liquid separator can be recycled back as the catholyte feed of the electrolyzer where it is further concentrated.

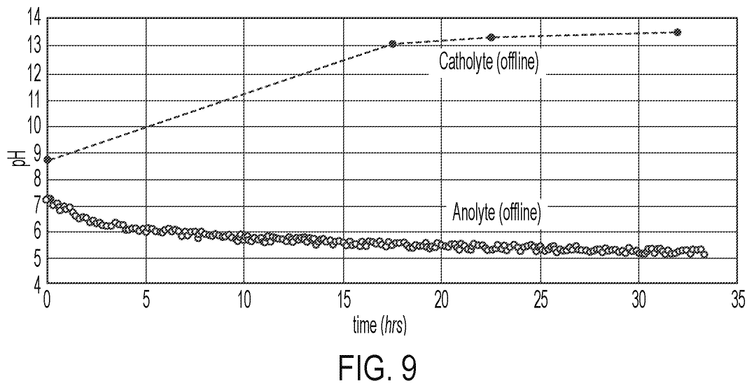

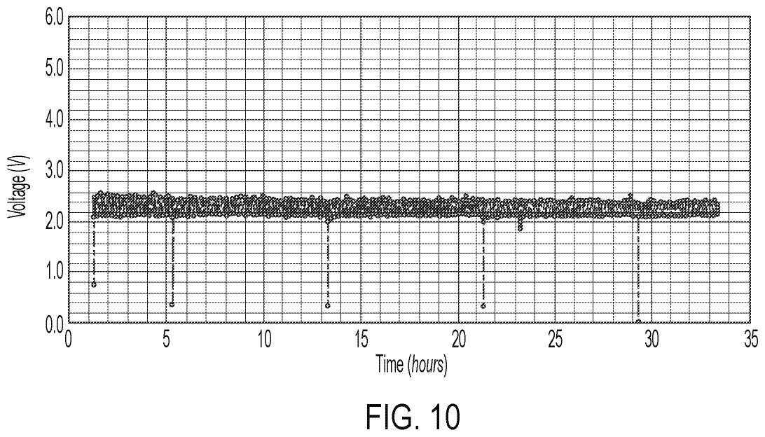

FIG. 9 shows the pH measured of the catholyte and anolyte over time of the system of FIG. 8 when operating at 1 kA/m² with a 10 cm² area electrolyzer with a platinum catalyst containing carbon paper anode and nickel foam cathode. The solution initial on both sides of the electrolyzer was 4M sodium acetate and maintained at approximately 77° C. As can be seen in FIG. 9, the pH of the catholyte increases demonstrating the concentration of NaOH while the pH of the anolyte decreases towards the pKa of acetic acid demonstrating the conversion of acetic acid over time. FIG. 10 shows the voltage of the electrolyzer, which operated at 2.2 volts consistently for 33 hours straight for the test.

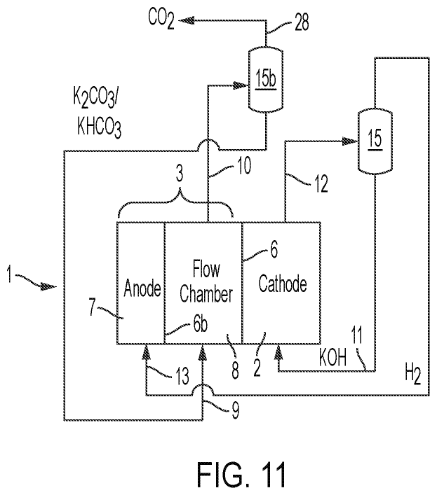

FIG. 11 illustrates an exemplary setup tested in a laboratory setting to simulate the performance of an electrolyzer described in a carbon dioxide separation embodiment. Electrolyzer 1 includes a depolarized anode in an anode-containing compartment 7 supplied with hydrogen 13 separated from an anolyte compartment 8 by a cation exchange membrane 6b. The anolyte in the anolyte compartment 8 includes potassium carbonate and bicarbonate solution. The anolyte is further in contact with a cation-selective membrane 6. On the opposite side of the membrane is a potassium hydroxide cathode compartment 2 containing the catholyte and cathode that can support HER. The hydrogen generated by the reaction at the cathode can leave the electrolyzer with the catholyte exit in stream 12 and enter the gas/liquid separator 15. The hydrogen gas 13 can exit the gas/liquid separator and can be injected into the anode compartment 3 (specifically, the anode-containing compartment 7). The hydrogen gas can be oxidized at the hydrogen depolarized anode generating protons that can react with the potassium carbonate and bicarbonate in the anolyte to release carbon dioxide and form water while the potassium cations can cross the cation exchange membrane 6 towards the cathode compartment. As a result, the anolyte exiting the electrolyzer in stream 10 contains gaseous and dissolved carbon dioxide as it enters the gas/liquid separator 15 b (e.g., anolyte flash tank and reservoir). In this electrolyzer test setup, the anolyte can be recirculated back to the electrolyzer where additional carbonate and bicarbonate can be converted to carbon dioxide. The potassium hydroxide 11 can exits gas/liquid separator 15 and can be recycled back as the catholyte inlet stream 11 of the electrolyzer where it can be further concentrated.

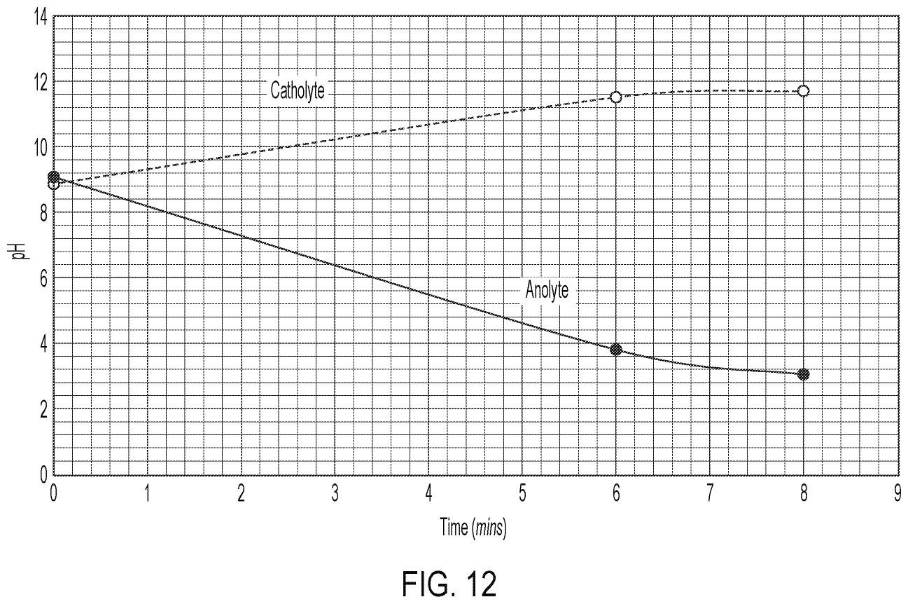

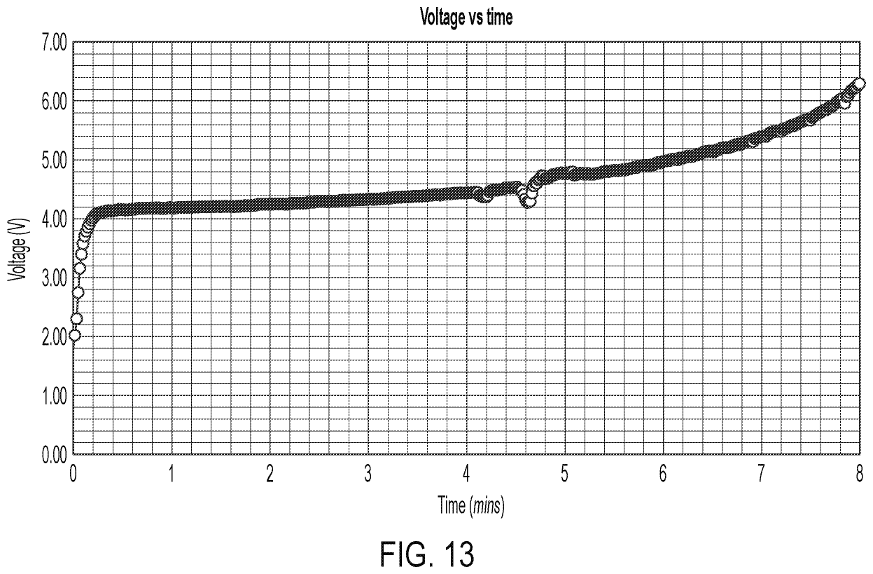

FIG. 12 shows the pH measured of the catholyte and anolyte over time of the system of FIG. 11 when operating at 1 kA/m² with a 10 cm² area electrolyzer with a platinum catalyst containing carbon paper anode and nickel foam cathode. The solution initial on both sides of the electrolyzer was 1M sodium sulfate and maintained at approximately 70° C. As can be seen in FIG. 12, the pH of the catholyte increases demonstrating the concentration of NaOH while the pH of the anolyte decreases towards the pKa of sodium bisulfate demonstrating the conversion of sulfate to bisulfate over time. FIG. 13 shows the voltage of the electrolyzer, which operated at approximately 4-5 volts during the test. Voltages could be reduced through use of higher concentration electrolytes, which would reduce ohmic potentials.

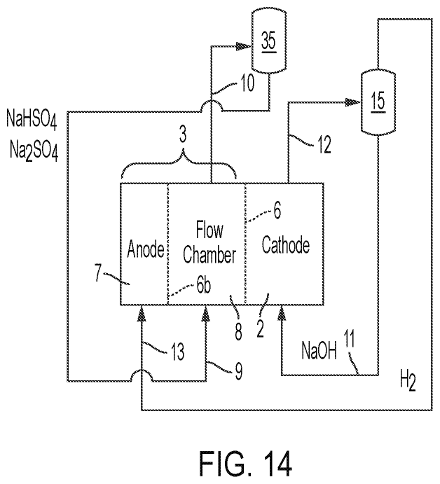

FIG. 14 illustrates an exemplary setup tested in a laboratory setting to simulate the performance of an electrolyzer described in a metal leaching embodiment. Electrolyzer 1 includes a depolarized anode in an anode-containing compartment 7 supplied with hydrogen 13 separated from an anolyte compartment 8 by a cation exchange membrane 6b. The anolyte in the anolyte compartment 8 includes sodium sulfate and sodium bisulfate. The anolyte is further in contact with a cation-selective membrane 6. On the opposite side of the membrane is a potassium hydroxide cathode compartment 2 containing the catholyte and cathode that can support HER. The hydrogen generated by the reaction at the cathode can leave the electrolyzer with the catholyte exit in stream 12 and enter the gas/liquid separator 15. The hydrogen gas 13 can exit the gas/liquid separator and can be injected into the anode compartment 3 (specifically, the anode-containing compartment 7). The hydrogen gas can be oxidized at the hydrogen depolarized anode generating protons that can react with the sodium sulfate in the anolyte to form sodium bisulfate. As a result, the anolyte exiting the electrolyzer in stream 10 contains sodium bisulfate with sodium sulfate and is sent to the anolyte reservoir, 35. In this electrolyzer test setup, the anolyte can be recirculated back from the reservoir to the electrolyzer where additional sodium sulfate can be converted to sodium bisulfate. The sodium hydroxide can exit gas/liquid separator 15 and can be recycled back as the catholyte inlet stream 11 of the electrolyzer where it can be further concentrated.

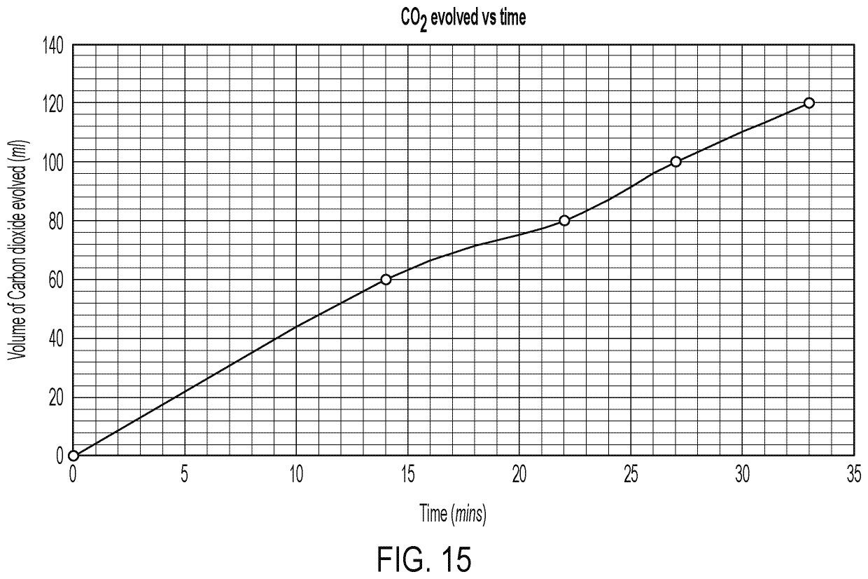

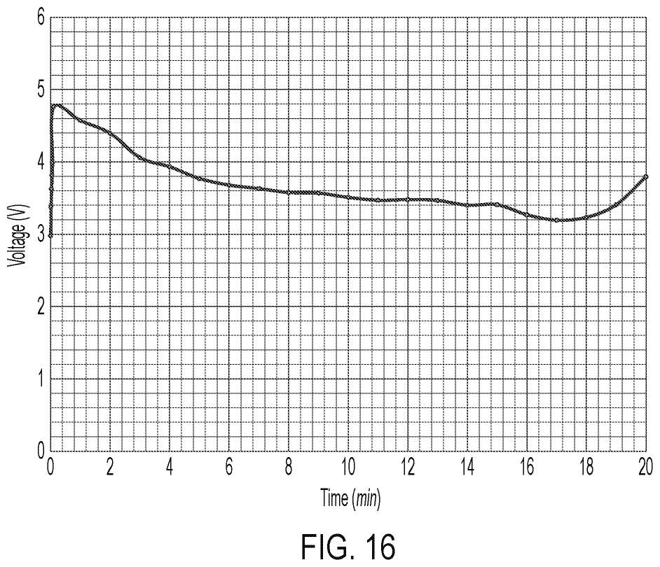

FIG. 15 shows the evolution of CO₂ over time of the system of FIG. 14 when operating at 0.2 kA/m² with a 10 cm² area electrolyzer with a platinum catalyst containing carbon paper anode and nickel foam cathode. The catholyte used for this experiment was 2M potassium hydroxide and the anolyte was 1M potassium bicarbonate. The test was run at 25° C. to highlight the generation of carbon dioxide from electrochemical means rather than from thermal decomposition of the bicarbonate. As can be seen in FIG. 15, the current induced a release of CO₂ of about 3.6 mL/min from the bicarbonate solution, consistent with one electron translating to one proton decomposing one molecule of CO₂. FIG. 16 shows the voltage of the electrolyzer, which operated from approximately 3-4 volts during the test. Lower voltages could be achieved through operation at higher temperatures and with more concentrated electrolytes.

### ENUMERATED EMBODIMENTS

The following enumerated embodiments are representative of some aspects disclosed herein:

Embodiment 1: A method to perform a pH influenced chemical or biological reaction comprising: an electrolyzer including an anode compartment and a cathode compartment; an anode in the anode compartment where an oxidation reaction occurs; a cathode in the cathode compartment where a reduction reaction occurs; a catholyte solution in contact with the cathode directly or through an ion conductive barrier that exits the cathode compartment at a higher pH than it enters the cathode compartment; an anolyte solution in contact with an anode directly or through an ion conductive barrier that exits the anode compartment at a lower pH than it enters the anode compartment; an ion conductive barrier separating the anode compartment from the cathode compartment; a dissolved component within either the anolyte, catholyte, or both that acts as a pH buffer; a gas evolved from one of the electrodes that is consumed at the other electrode; a second ion conductive barrier separating the electrode where gas is consumed from the liquid anolyte or catholyte; using the anolyte or catholyte streams to perform a pH influenced reaction;

and combining portions of the anolyte and catholyte streams into a neutralized stream and then feeding the neutralized stream back into the electrolyzer.

Embodiment 2: The method of embodiment 1, where the anolyte includes an organic acid.

Embodiment 3: The method of embodiment 1, where the anolyte includes an inorganic acid.

Embodiment 4: The method of embodiment 1, where an acetate salt is converted to acetic acid in the anode compartment.

Embodiment 5: The method of embodiment 1, where a carbonate salt is acidified causing the release of carbon dioxide.

Embodiment 6: The method of embodiment 1, where hydrogen is evolved at the cathode and hydrogen is consumed in the anode.

Embodiment 7: The method of embodiment 1, where oxygen is evolved at the anode and oxygen is consumed at the cathode.

Embodiment 8: The method of embodiment 1, where the catholyte includes ammonia and/or ammonium.

Embodiment 9: The method of embodiment 1, where the catholyte includes an amine.

Embodiment 10: The method of embodiment 1, where the catholyte includes an organic base.

Embodiment 11: The method of embodiment 1, where the catholyte includes an inorganic base.

Embodiment 12: The method of embodiment 1, where the anolyte exiting the anode compartment is used to extract an acid or base soluble species.

Embodiment 13: A method to capture and concentrate an acid gas comprising: an electrolyzer including an anode compartment and a cathode compartment; an anode in the anode compartment where an oxidation reaction occurs; a cathode in the cathode compartment where a reduction reaction occurs; a catholyte solution in contact with the cathode directly or through an ion conductive barrier that exits the cathode compartment at a pH greater than 7; an anolyte solution in contact with an anode directly or through an ion conductive barrier that exits the anode at a pH less than 6; a cation exchange membrane separating the anode compartment from the cathode compartment; the acid gas is evolved in the anolyte compartment; hydrogen gas evolved from the cathode that is consumed at the anode; a cation exchange membrane separating the hydrogen and anode from the anolyte; the catholyte to capture absorb the acid gas; using the acid gas-rich catholyte as the anolyte feed to the electrolyzer.

Embodiment 14: The method of embodiment 13, where the carbon capture system is used to capture CO₂ directly from air.

Embodiment 15: The method of embodiment 14, where the catholyte comprises hydroxides at a concentration of 1 molar or greater.

Embodiment 16: The method of embodiment 13, where the carbon capture system is used to capture CO₂ from a stream with greater than 1% carbon dioxide by volume.

Embodiment 17: The method of embodiment 16, where the catholyte comprises a carbonate salt or amine or combination thereof.

Embodiment 18: A method to extract a valuable component from a feedstock comprising: an electrolyzer including an anode compartment and a cathode compartment; an anode in the anode compartment where an oxidation reaction occurs; a cathode in the cathode compartment where a reduction reaction occurs; a catholyte solution in contact with the cathode directly or through an ion conductive barrier that exits the cathode compartment at a pH greater than 7; an anolyte solution in contact with an anode directly or through an ion conductive barrier that exits the anode at a pH less than 6; a cation exchange membrane separating the anode compartment from the cathode compartment; hydrogen gas evolved from the cathode that is consumed at the anode; a cation exchange membrane separating the hydrogen and anode from the anolyte; using the catholyte or anolyte as a leach solution and placing it in contact with a feedstock with a first concentration of a target element; extracting a portion of the target element into the leach solution; separating the leach solution from the residue of the feedstock; recovering the target element from the leach solution; recycling the leach solution to the electrolyzer.

Embodiment 19: The method of embodiment 18, where, the anolyte is used as the leach solution and comprises an organic acid.

Embodiment 20: The method of embodiment 18, where the anolyte is used as the leach solution and comprises and inorganic acid.

Embodiment 21: The method of embodiment 19, where the organic acid comprises acetic acid.

Embodiment 22: The method of embodiment 20, where the inorganic acid comprises bisulfate.

Embodiment 23: The method of embodiment 18, where the leach solution is the anolyte and the target element is magnesium or calcium and is recovered through precipitation as a hydroxide by adding the catholyte to the leach solution.

Embodiment 24: The method of embodiment 18, where the leach solution is the anolyte and the target element is a transition metal such as nickel, copper, cobalt, chromium, or manganese and is recovered through electrowinning.

Embodiment 25: The method of embodiment 18, where the leach solution is the catholyte and comprises potassium or sodium hydroxide.

Embodiment 26: The method of embodiment 25, where the target element is aluminum.

Embodiment 27: The method of embodiment 25, where the target element is a platinum group metal or rare earth metal.

Embodiment 28: The method of embodiment 18, where the anolyte exiting the anode compartment is used to dissolve a slag generated from a furnace or boiler

Embodiment 29: The method of embodiment 18, where the anolyte exiting the anode compartment is used to dissolve an ash generate from a furnace or boiler

Embodiment 30: The method of embodiment 18, where the anolyte exiting the anode compartment is used to dissolve a naturally occurring rock or stone.

Embodiment 31: The method of embodiment 18, where the anolyte exiting the anode compartment is used to dissolve a metal salt containing material and the catholyte exiting the cathode compartment is used to precipitate the dissolved material into one or more metal hydroxides or metal oxides.

Embodiment 32: The method of embodiment 31, used to produce calcium hydroxide from a calcium containing material

Embodiment 33: The method of embodiment 32, where the calcium hydroxide is produced for the purposes of creating a cementitious product.

Embodiment 34: The method of embodiment 13, used to perform a separation of an acid gas.

Embodiment 35: The method of embodiment 13, used to perform a separation of sulfur oxide gases.

Embodiment 36: The method of embodiment 13, used to perform a separation of nitrogen oxide gases.

Embodiment 37: The method of embodiment 13, used to perform a separation of reduced sulfur gases including hydrogen sulfide.

Embodiment 38: A method to capture and concentrate a basic gas comprising: an electrolyzer including an anode compartment and a cathode compartment; an anode in the anode compartment where an oxidation reaction occurs; a cathode in the cathode compartment where a reduction reaction occurs; a catholyte solution in contact with the cathode directly or through an ion conductive barrier that exits the cathode compartment at a pH greater than 7; an anolyte solution in contact with an anode directly or through an ion conductive barrier that exits the anode at a pH less than 6; an ionically conductive barrier separating the anode compartment from the cathode compartment; the basic gas is evolved in the catholyte compartment; hydrogen gas evolved from the cathode that is consumed at the anode; a cation exchange membrane separating the hydrogen and anode from the anolyte; using the anolyte to capture absorb the acid gas; using the basic gas-rich anolyte as the catholyte feed to the electrolyzer.

Embodiment 39: The method of embodiment 38, used to perform a separation of a basic gas.

Embodiment 40: The method of embodiment 38, used to separate and/or concentrate ammonia.

Embodiment 41: The method of embodiment 40, used to dissolve and precipitate silica.

Embodiment 42: The method of embodiment 40, used to dissolve and precipitate alumina.

Embodiment 43: The method of embodiment 40, used to dissolve and precipitate aluminosilicates

Embodiment 44: The method of embodiment 1, where chlorine is evolved at the anode and consumed at the cathode

Embodiment 45: A method comprising, operating a system and/or device according to any of embodiments 1-44.

Embodiment 46: A system and/or device configured to perform the operations of the methods of any of embodiments 1-44.

### ADDITIONAL DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that the fraction of the weak acid present in its conjugate base form may be less than about 100%, about 90%, or about 80% is meant to mean that the fraction of the weak acid present in its conjugate base from may be less than about 100%, less than about 90%, or less than about 80%.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
generating hydrogen gas in a cathode compartment of an electrolyzer, wherein the cathode compartment comprises a catholyte and a cathode;
sending the hydrogen gas to an anode-containing compartment of the electrolyzer, wherein the anode-containing compartment comprises an anode and is separated from an anolyte compartment comprising a pH buffer by a first ion-selective barrier and the anolyte compartment is separated from the cathode compartment by a second ion-selective barrier;
oxidizing the hydrogen gas in the anode-containing compartment generating protons; and
generating an acid in the anolyte compartment with the protons received through the ion-selective barrier.

2. The method of claim 1, wherein the open-circuit potential of the electrolyzer is less than 1 volt.

3. The method of any one of claims 1-2, wherein the pH buffer comprises a weak acid and its conjugate base.

4. The method of claim 3, wherein the weak acid comprises acetic acid, a bicarbonate, or a bisulfate and the conjugate base comprises acetate, a carbonate, or a sulfate.

5. The method of any one of claims 1-4, further comprising dissolving a feedstock material comprising a target element with the acid and precipitating and/or electrodepositing the target element from the dissolved feedstock material.

6. The method of claim 5, wherein precipitating and/or electrodepositing the target element from the dissolved feedstock material uses the catholyte.

7. The method of any one of claims 1-6, further comprising separating the hydrogen gas from the catholyte.

8. The method of any one of claims 1-7, further comprising capturing an acid gas from a gas mixture with the catholyte and sending the catholyte with the captured acid gas to the anolyte compartment.

9. The method of any one of claims 1-8, further comprising generating an acid gas in the anolyte compartment.

10. The method of claim 9, further comprising separating the acid gas from the anolyte.

11. A system comprising:
an electrolyzer comprising:
a cathode compartment comprising a catholyte and a cathode; and
an anode compartment comprising an anolyte compartment comprising a pH buffer and an anode-containing compartment comprising an anode,
wherein:
the cathode compartment is separated from the anode compartment by a first ion-selective barrier and the anolyte compartment is separated from the anode-containing compartment by a second ion-selective barrier;
the cathode compartment is configured to generate hydrogen gas;
the anode-containing compartment is configured to receive the hydrogen gas and oxidize the hydrogen gas generating protons; and
the anolyte compartment is configured to receive the protons through the second ion-selective barrier and generate an acid.

12. The system of claim 11, further comprising a dissolution reactor configured to receive the acid from the anolyte compartment and dissolve a feedstock material comprising a target element.

13. The system of claim 12, further comprising a precipitation reactor configured to receive the dissolved feedstock material and precipitate the target element from the dissolved feedstock material.

14. The system of any one of claims 11-13, further comprising a gas/liquid separator configured to receive a catholyte exit stream from the cathode compartment and separate the catholyte exit stream into hydrogen gas and the catholyte.

15. The system of claim 14, wherein the hydrogen gas from the gas/liquid separator is sent to the anode-containing compartment.

16. The system of any one of claims 14-15, wherein at least a portion of the catholyte from the gas/liquid separator is sent to the cathode compartment.

17. The system of any one of claims 14-16, wherein at least a portion of the catholyte from the gas/liquid separator is sent to a precipitation reactor to precipitate a target element from a dissolved feedstock material.

18. The system of any one of claims 14-17, further comprising an absorber configured to receive a portion of the catholyte from the gas/liquid separator, to receive a gas mixture comprising an acid gas, and to capture the acid gas in the catholyte.

19. The system of claim 18, wherein the catholyte with the captured acid gas is sent to the anolyte compartment.

20. The system of any one of claims 11-19, wherein the anolyte compartment is configured to generate an acid gas.

21. The system of claim 20, further comprising a second gas/liquid separator configured to receive an anolyte product and separate the anolyte product into an acid gas and the anolyte.

22. The system of claim 21, wherein at least a portion of the anolyte from the second gas/liquid separator is sent to the anolyte compartment.

23. The system of any one of claims 11-22, wherein the electrolyzer has an open-circuit potential of less than 1 volt.

24. The system of any one of claims 11-13, wherein the pH buffer comprises a weak acid and its conjugate base.

25. The system of claim 24, wherein the weak acid comprises acetic acid, a bicarbonate, or a bisulfate and the conjugate base comprises acetate, a carbonate, or a sulfate.

26. An electrolyzer comprising:
a cathode compartment comprising a catholyte and a cathode; and
an anode compartment comprising an anolyte compartment comprising a pH buffer and an anode-containing compartment comprising an anode,
wherein:
the cathode compartment is separated from the anode compartment by a first ion-selective barrier and the anolyte compartment is separated from the anode-containing compartment by a second ion-selective barrier;
the cathode compartment is configured to generate hydrogen gas;
the anode-containing compartment is configured to receive the hydrogen gas and oxidize the hydrogen gas generating protons; and
the anolyte compartment is configured to receive the protons through the second ion-selective barrier and generate an acid.

27. The electrolyzer of claim 26, wherein the electrolyzer has an open-circuit potential of less than 1 volt.

28. The electrolyzer of any one of claims 26-27, wherein the pH buffer comprises a weak acid and its conjugate base.

29. The electrolyzer of claim 28, wherein the weak acid comprises acetic acid, a bicarbonate, or a bisulfate and the conjugate base comprises acetate, a carbonate, or a sulfate.
